(19) United States
(12) Patent Application Publication
(10) Pub. No.: US 2026/0213232 A1
(43) Pub. Date: Jul. 23, 2026

(54) HYDROGEN DISTRIBUTION SYSTEM COMPRISING FUEL CELLS AND METHODS OF USING THE SAME

(71) Applicant: Jinetics Inc., Mountain View, CA (US)

(72) Inventors: Shicheng Xu, Mountain View, CA (US); Michael Paszti, Mountain View, CA (US)

(73) Assignee: Jinetics Inc., Mountain View, CA (US)

(21) Appl. No.: 19/455,596

(22) Filed: Jan. 21, 2026

Related U.S. Application Data
(60) Provisional application No. 63/748,389, filed on Jan. 22, 2025.

(51) Int. Cl. H01M 8/04082; H01M 4/90; H01M 8/04089; H01M 8/0612; H01M 8/1065

(52) U.S. Cl. CPC H01M 8/04201; H01M 4/9058; H01M 8/04097; H01M 8/0618; H01M 8/1065; H01M 2300/0082

(57) ABSTRACT

Disclosed herein is a hydrogen distribution system comprising: a plurality of fuel cells, each fuel cell comprising: an anode; a cathode; an anode-side syngas inlet configured to introduce a syngas to the anode from a hydrocarbon fuel reformer (HR); a cathode-side hydrogen outlet configured to output a purified hydrogen from the cathode and coupled to a hydrogen exhaust line having a first valve; an anode-side hydrogen inlet configured to introduce purified hydrogen from the hydrogen exhaust line to the anode and coupled to a second valve; an anode-side syngas outlet configured to output a hydrogen-depleted syngas to a HR burner; and an electronic control unit configured to electrically control the valves, wherein the anode-side syngas outlet recycles hydrogen-depleted syngas, via an anode outlet line, to a HR burner used in the production of the syngas.

### RELATED APPLICATIONS

This application claims the benefit of and priority to U.S. Provisional Ser. No. 63/748,389, filed Jan. 22, 2025, the contents of which is incorporated herein by reference in its entirety.

### BACKGROUND

Hydrogen fuel cells enable clean energy for transportation, including cars, buses, and ships, and power critical infrastructure such as hospitals and data centers. Fuel cell-based hydrogen production systems are also used across residential, industrial, and grid applications. In residential settings, these systems power microgrids and provide backup energy with minimal emissions, while in industries, they drive processes like metal refining, ammonia production, and methane abatement. Additionally, they integrate well with renewable energy sources, offering a sustainable and efficient method for balancing energy supply and demand, especially in grid or off-grid scenarios.

Despite their potential, the efficiency and scalability of hydrogen production systems remain a key challenge. Traditional methods like steam methane reforming are energy-intensive and often rely on fossil fuels, contributing to greenhouse gas emissions. Developing more efficient, low-carbon hydrogen production methods is crucial to meeting global energy demands sustainably. Therefore, there exists a need for new hydrogen production technologies, which rely on recycling waste carbon oxides, hydrogen, and water to improve energy efficiency and reduce the emission of pollutants.

### SUMMARY

In one aspect, which may be combined with any other aspect or embodiment, the present disclosure relates to a hydrogen distribution system comprising:
an air source;
a plurality of fuel cells, each fuel cell comprising:
   an anode;
   a cathode;
   an electrolyte membrane between the anode and the cathode;
   an anode-side syngas inlet configured to introduce a syngas to the anode from a hydrocarbon fuel reformer (HR);
   a cathode-side hydrogen outlet configured to output a purified hydrogen from the cathode and coupled to a hydrogen exhaust line having a first valve;
   an anode-side hydrogen inlet configured to introduce purified hydrogen from the hydrogen exhaust line to the anode and coupled to a second valve;
   a cathode-side air inlet configured to introduce air from the air source to the cathode and coupled to a third valve;
   an anode-side syngas outlet configured to output a hydrogen-depleted syngas to a HR burner;
   a cathode-side water exhaust outlet configured to output water from the cathode and coupled to a fourth valve; and
   an electronic control unit configured to electrically control the first valve, the second valve, the third valve, and the fourth valve,
   wherein the anode-side syngas outlet recycles hydrogen-depleted syngas, via an anode outlet line, to a HR burner used in the production of the syngas.

In some embodiments, the cathode-side water exhaust outlet recycles water to the HR via a cathode outlet line; the first valve is opened and the third and fourth valves are closed in a hydrogen production mode, thereby reducing cathode impurities; the first valve is closed and the third and fourth valves are opened in an electricity production mode; and the second valve is opened to dilute the syngas with the purified hydrogen, thereby reducing anode impurities.

In some embodiments, the HR is a methane reformer configured to convert methane into hydrogen and carbon oxides via steam reformation and/or pyrolysis processes.

In some embodiments, the fuel cells are polymer electrolyte membrane fuel cells (PEMFCs). In some embodiments, the PEMFCs each comprise one or more catalyst layers contacting the electrolyte membrane, and wherein the one or more catalyst layers comprise a platinum group metal (PGM). In some embodiments, the PGM is selected from the group consisting of platinum, palladium, rhodium, ruthenium, osmium, and iridium.

In some embodiments, each of the fuel cells in the plurality of fuel cells is configured to operate in two modes:
(1) an electricity-producing mode to produce electricity using hydrogen in the syngas; and
(2) a hydrogen-producing mode to consume electricity and produce hydrogen for use in the HR burner, for storage, or for distribution,
wherein the mode of a fuel cell is selected based on a voltage produced by the fuel cell.

In some embodiments, at least one of the plurality of fuel cells further comprises a cathode-side liquid inlet coupled to a fifth valve, and wherein the cathode-side liquid inlet is configured to supply liquid to the cathode to increase electrical output of the fuel cell. In some embodiments, the liquid comprises a proton donor. In some embodiments, the liquid comprises water, methanol, or a combination thereof.

In another aspect, which may be combined with any other aspect or embodiment, the present disclosure relates to a fuel cell system comprising:
a HR configured to convert a hydrocarbon fuel into a syngas;
a burner configured to heat the HR; and
the hydrogen distribution system according to claim 1 in fluid communication with the anode-side syngas inlet and the cathode-side hydrogen exhaust outlet;
wherein the HR comprises an HR outlet coupled to the anode-side syngas inlet by an anode syngas inlet line;
wherein excess hydrogen is transferred from the anode-side outlet into the burner via the anode outlet line;
wherein water is transferable from the cathode-side water exhaust outlet to the HR via a water exhaust line;
wherein air is introduced from the air compressor into the cathode-side air inlet; and
wherein the cathode-side air outlet outputs air exhaust from the cathode into an air exhaust line configured to introduce air into the burner.

In some embodiments, the plurality of fuel cells are polymer electrolyte membrane fuel cells (PEMFCs). In some embodiments, the PEMFCs each comprise one or more catalyst layers contacting the electrolyte membrane, and wherein the one or more catalyst layers comprise a platinum group metal (PGM). In some embodiments, the PGM is selected from the group consisting of platinum, palladium, rhodium, ruthenium, osmium, and iridium.

In some embodiments, the fuel is methane, the HR is a SMR, and the methane is introduced into the SMR at <5 bar. In some embodiments, the syngas is introduced into the anode-side syngas inlet at <3 bar.

In some embodiments, at least one of the plurality of fuel cells further comprises a cathode-side methanol/water mixture inlet coupled to a fifth valve, and wherein the cathode-side methanol inlet is configured to supply methanol to the cathode to increase electrical output of the fuel cell.

In another aspect, which may be combined with any other aspect or embodiment, the present disclosure relates to a method for operating a fuel cell system, the method comprising:
providing the fuel cell system according to any of the embodiments disclosed herein;
producing syngas using the HR, wherein the HR is heated by the burner;
introducing the syngas into the hydrogen distribution system via an anode-side syngas inlet line coupled to the anode-side syngas inlet, wherein the syngas is introduced into a fuel cell at the anode-side syngas inlet;
producing electricity by consuming hydrogen gas in the syngas via the fuel cell; and
outputting excess hydrogen via the anode-side exhaust outlet to the burner to heat the HR.

In some embodiments, the method further comprises: producing water at the fuel cell on the cathode side and transferring the water from the cathode-side water exhaust outlet into the HR; and transferring air exhaust from the cathode via the cathode-side air outlet into the burner.

In some embodiments, the method further comprises:
operating a second fuel cell of the hydrogen distribution system in a hydrogen-producing mode to produce purified hydrogen gas at the cathode;
transferring the purified hydrogen gas via the cathode-side hydrogen outlet into at least one of the hydrogen exhaust, or an anode-side inlet of a fuel cell in the hydrogen distribution system operating in an electricity-producing mode.

In some embodiments, the fuel cell is a polymer electrolyte membrane fuel cell (PEMFC). In some embodiments, the PEMFCs each comprise one or more catalyst layers contacting the membrane, and wherein the one or more catalyst layers comprise a platinum group metal (PGM). In some embodiments, the PGM is selected from the group consisting of platinum, palladium, rhodium, ruthenium, osmium, and iridium.

In some embodiments, the fuel is methane, the HR is a SMR, and the methane is introduced into the SMR at <5 bar. In some embodiments, the syngas is introduced into the anode-side syngas inlet at <3 bar.

In some embodiments, an amount of excess hydrogen or purified hydrogen introduced into the HR is controlled by the electronic control unit based on (i) a voltage produced by the one or more fuel cells, and/or (ii) temperature of the burner.

In some embodiments, the method further comprises providing methanol to a fuel cell cathode to increase electrical output of the fuel cell.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 shows a schematic illustration of fuel cell system including a hydrocarbon reformer and hydrogen distribution device.

FIG. 2 is a schematic illustration of a hydrogen distribution device including a plurality of fuel cells.

FIG. 3 is a schematic illustration of a hydrogen distribution system including an electronic control unit.

FIG. 4 shows a schematic illustration of a fuel cell including a polymer electrolyte membrane (“PEM”).

### DETAILED DESCRIPTION

Reference will now be made in detail to some specific embodiments contemplated by the present disclosure. While various embodiments are described herein, it will be understood that it is not intended to limit the present technology to the described embodiments. On the contrary, it is intended to cover alternatives, modifications, and equivalents as may be included within the spirit and scope of the technology as defined by the appended claims.

In the following description, numerous specific details are set forth in order to provide a thorough understanding of the present technology. Particular exemplary embodiments of the present technology may be implemented without some or all of these specific details. In other instances, well known process operations have not been described in detail in order not to unnecessarily obscure the present technologies.

Various techniques and mechanisms of the present technology will sometimes be described in singular form for clarity. However, it should be noted that some embodiments include multiple iterations of a technique or multiple instantiations of a mechanism unless noted otherwise.

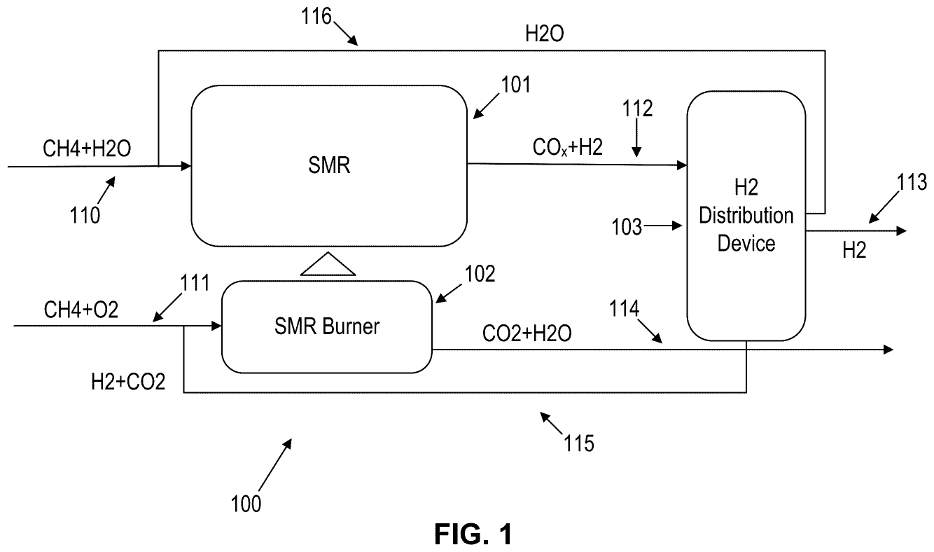

To guide the description of hydrogen distribution systems and fuel cell systems according to the present disclosure, reference is made, by way of non-limiting example, to particular embodiments of the present technology. Referring to FIG. 1, in one embodiment, fuel cell system 100 is assembled using steam methane reformer (SMR) 101, SMR burner 102, and hydrogen distribution device 103.

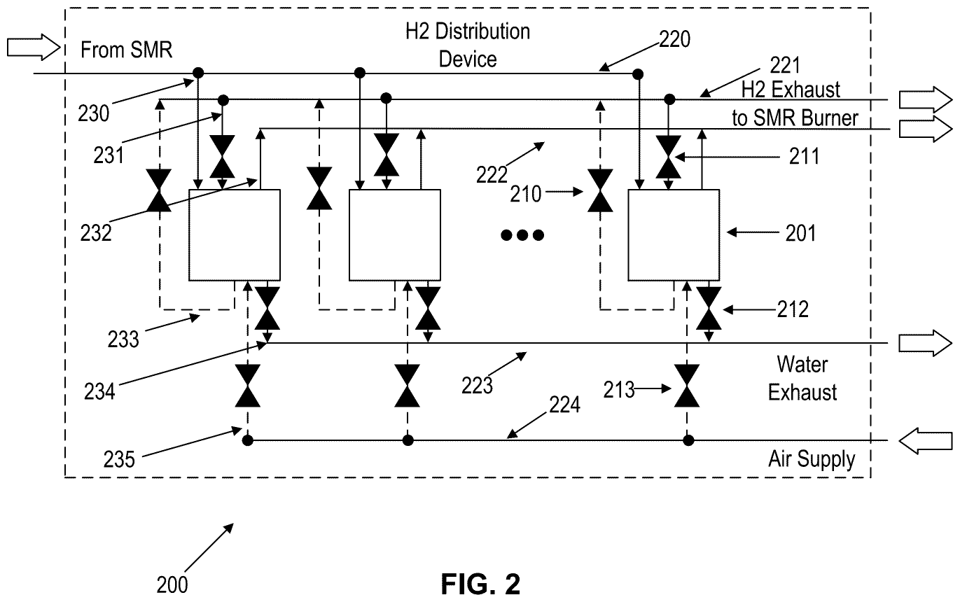

Referring still to FIG. 1, SMR 101 is positioned adjacent to SMR burner 102, with SMR burner 102 configured the heat SMR 101. Line 110 provides a hydrocarbon fuel (e.g., methane) and water to the SMR, and line 111 proves a hydrocarbon fuel (e.g., methane) and oxygen to the SMR burner. In some embodiments, line 110 provides hydrocarbon fuel to SMR 101 at a pressure of <5 bar. SMR burner 102 converts the hydrocarbon fuel into (i) heat, thereby heating SMR 101, and (ii) a carbon dioxide and water byproduct, which exits fuel cell system 100 through line 114. SMR 101 converts the hydrocarbon fuel into a carbon dioxide and hydrogen gas product (e.g., syngas). Line 112 provides the carbon dioxide and hydrogen gas product of SMR 101 to hydrogen distribution device 103. In some embodiments, line 112 provides the carbon dioxide and hydrogen gas product to hydrogen distribution device 103 at a pressure of <3 bar. Hydrogen distribution device 103, comprising a plurality of fuel cells (see FIG. 2), converts the carbon dioxide and hydrogen gas product into (i) electricity, (ii) a hydrogen gas byproduct, which exits fuel cell system 100 through line 113, (iii) a water byproduct, which is recycled into SMR 101 through line 116, and (iv) a hydrogen and carbon dioxide gas byproduct, which is recycled into SMR burner 102 through line 115. In some embodiments, the hydrogen and carbon dioxide gas byproduct is recycled into SMR burner 102 based on (i) a voltage produced by the one or more fuel cells, and/or (ii) the temperature of SMR burner 102.

One of skill in the art will understand that the terms “lines,” and “sub lines,” as used herein include any hollow passage capable of communicating or transmitting gas or liquid from an outlet to an inlet, an inlet to an outlet, or any combinations thereof.

Referring now to FIG. 2, in one embodiment hydrogen distribution device 200 is assembled using a plurality of fuel cells 201. Line 220 provides a carbon dioxide and hydrogen gas product (e.g., syngas) from a SMR to the plurality of fuel cells 201, which is distributed to the anode side of each fuel cell of the plurality of fuel cells 201 through sub lines 230. The carbon dioxide and hydrogen gas product contacts an anode within fuel cell 201, and hydrogen is depleted from the carbon dioxide and hydrogen gas product. Sub lines 232 provides the depleted carbon dioxide and hydrogen gas product to line 222, which provides the depleted carbon dioxide and hydrogen gas product to a SMR burner.

Referring still to FIG. 2, line 224 provides air to the plurality of fuel cells 201, which is distributed to the cathode side of each fuel cell of the plurality of fuel cells through sub lines 235, under the control of valves 213. The air contacts a cathode within fuel cell 201, and purified hydrogen and water is produced. Sub lines 234, under the control of valves 212, provides the water to line 224, which provides the water to the SMR. Sub lines 233, under the control of valves 210, provides the purified hydrogen to line 221, which provides the purified hydrogen to an exhaust.

Referring still to FIG. 2, sub lines 231, under the control of valves 211, also provides the purified hydrogen to the anode side of fuel cells 201. In some embodiments, valves 211 are opened to dilute the carbon dioxide and hydrogen gas product, thereby reducing anode impurities. In some embodiments, valves 210 are opened and valves 212 and 213 are closed to enter a hydrogen production mode of fuel cell 201, thereby reducing cathode impurities. In some embodiments valves 210 are closed and valves 212 and 213 are opened to enter an electricity production mode of fuel cell 201. In some embodiments, an additional line, under the control of a valve, provides a liquid to the cathode to increase electric output of fuel cell 201. In some embodiments, the liquid comprises any suitable proton donor. In some embodiments, the liquid comprises an alcohol (e.g., methanol, ethanol) and optionally water. In some embodiments, the liquid comprises methanol, water, or a combination thereof.

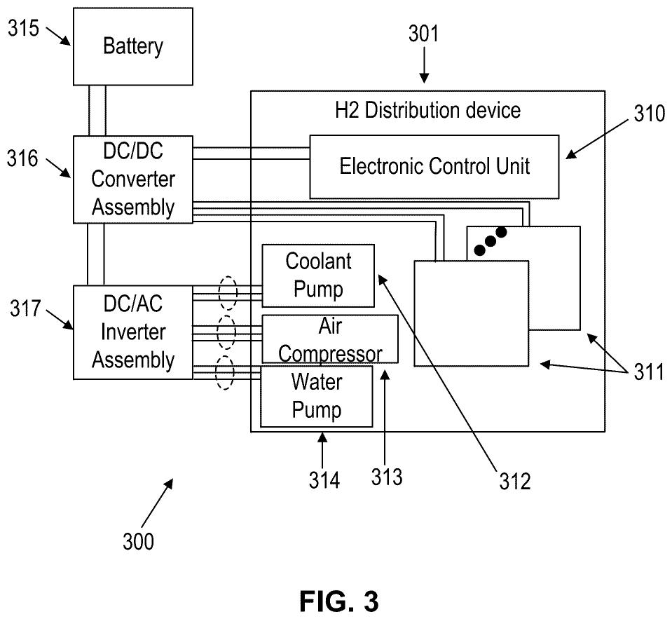

Referring now to FIG. 3, in one embodiment hydrogen distribution system 300 is assembled using hydrogen distribution device 301, communicably coupled to battery 315, DC/DC converter assembly 316, and DC/AC inverter assembly 317. In some embodiments, hydrogen distribution device 301 comprises a plurality of fuel cells 311 communicably coupled to electronic control unit 310. In some embodiments, hydrogen distribution device 301 further comprises coolant pump 312, air compressor 313, and water pump 314 communicably coupled to electronic control unit 310.

Referring still to FIG. 3, in some embodiments, electronic control unit 310 controls valves of the plurality of fuel cells 311. In some embodiments, the valves (see FIG. 2) of at least one fuel cell of the plurality of fuel cells 311 is configured by electronic control unit 310 for the fuel cell to enter an electricity-producing mode, and the valves of at least one fuel cell of the plurality of fuel cells 311 is configured to enter a hydrogen-producing mode. In some embodiments, the mode is selected based on a voltage produced by a fuel cell of the plurality of fuel cells.

Referring still to FIG. 3, in some embodiments, electronic control unit 310 controls water pump 314. In some embodiments, water pump 314 transfers water from the cathode side of fuel cell of the plurality of fuel cells 311 to a SMR (see FIG. 1, FIG. 2). In some embodiments, electronic control unit 310 controls air compressor 313. In some embodiments, air compressor 313 transfers air to the cathode side of a fuel cell of a plurality of fuel cells 311 (see FIG. 2). In some embodiments, electronic control unit 310 controls coolant pump 312. In some embodiments, coolant pump 312 transfers coolant around the plurality of fuel cells, thereby cooling the plurality of fuel cells. In some embodiments, battery 315 is communicably coupled to electronic control unit 310 and the plurality of fuel cells 311. In some embodiments, battery 315 powers electronic control unit 310 and the plurality of fuel cells 311. In some embodiments, battery 315 stores electricity produced by the plurality of fuel cells 311.

### Hydrocarbon Reformation

In some embodiments, a hydrogen distribution system according to the present disclosure comprises a hydrocarbon reformer. Hydrocarbon reformation is a process used to convert hydrocarbons, typically in the form of natural gas or liquid fuels, into hydrogen gas and/or other byproducts. In some embodiments, hydrocarbon reformation is employed in combination with fuel cells, wherein the hydrogen produced via reforming is utilized for electrochemical reactions. Fuels (e.g., methane, propane, gasoline, methanol, ethanol, kerosene, or biomass) are reformed into hydrogen and carbon-containing byproducts, usually carbon monoxide and/or carbon dioxide, through various chemical reactions. In some embodiments, the hydrocarbon reformation is steam reforming, but other methods, such as partial oxidation or autothermal reforming, may also be used.

Steam reforming involves the reaction of hydrocarbons with steam at high temperatures in the presence of a catalyst to produce hydrogen and carbon monoxide. In some embodiments, the carbon monoxide is typically further processed in a water-gas shift reaction to convert it into additional hydrogen and carbon dioxide, thereby increasing the yield of hydrogen.

In some embodiments, the hydrocarbon reformer may produce hydrogen via partial oxidation reforming, wherein hydrocarbons are partially combusted with oxygen to produce hydrogen and carbon monoxide. Partial oxidation may offer some process advantages in that it is faster than steam reforming and may be preferred when there is limited steam or when a higher concentration of carbon monoxide is acceptable.

In some embodiments, the hydrocarbon reformer may produce hydrogen via autothermal reforming, which combines attributes of steam reforming and partial oxidation reactions to produce hydrogen. Autothermal reforming uses both steam and oxygen as reactants in the reforming process, which allows for more efficient heat management. This method may be useful in cases where both heat and hydrogen are needed simultaneously, providing a balance between steam reforming and partial oxidation.

A variety of catalysts are used in the reformation process, depending on the feedstock and the specific process being employed. In some embodiments, the hydrogen reformer uses catalysts selected from: (i) nickel-based catalysts, often used for methane and other light hydrocarbons; (ii) platinum-based catalysts, often used with more complex hydrocarbon feedstocks such as gasoline or kerosene; and (iii) rhodium-based catalysts, sometimes used in high-temperature processes, such as partial oxidation, where higher reactivity is needed.

In some embodiments, the hydrocarbon reformer is a steam methane reformer (“SMR”). Steam methane reforming (“SMR”) produces hydrogen or syngas (i.e., a mixture of hydrogen and carbon oxides, such as carbon monoxide). To initiate SMR, methane is mixed with steam in a specified molar ratio (typically 3:1 steam to methane, but in some embodiments may be about 10:1, about 5:1, about 3:1, about 2:1, about 1:1 steam to methane), and the mixture is fed into a reforming reactor containing the catalyst. The SMR reaction occurs under high temperatures (e.g., 700-1100° C.) and pressures (3-25 bar). The SMR reaction produces product gas mixture (or syngas) comprising hydrogen, carbon monoxide, and carbon dioxide.

Because the steam reforming reaction is highly endothermic, the reactor is integrated with external heat sources, often provided by burning part of the methane feed or an auxiliary fuel. This heat is transferred to the reaction zone through radiant or convective heating. See, e.g., FIG. 1, SMR Burner 102.

In some embodiments, the hydrogen distribution system is supplied with hydrogen via a reactor different from an HR. In some embodiments, the reactor is a pyrolysis reactor. Compared to SMR, pyrolysis produces solid carbon as a by-product, thereby avoiding the direct emission of carbon dioxide. To initiate the reaction, feedstock is introduced into a pyrolysis reactor, where it undergoes thermal decomposition at high temperatures (typically 800-1300° C.) in the absence of oxygen. The pyrolysis reactor is configured to facilitate efficient heat transfer and ensure uniform temperature distribution. Pyrolysis reactor designs may include (i) fluidized-bed reactors, for enhanced mixing and uniform heating, (ii) plasma reactors, utilizing plasma arcs to achieve high temperatures, and (iii) catalytic reactors, which incorporate catalysts (e.g., nickel or iron) to lower the required temperature and improve reaction kinetics.

In some embodiments, the hydrocarbon fuel comprises methane or gas mixtures comprising methane (e.g., natural gas or biogas), ethane, propane, butane, gasoline, diesel fuel, kerosene, ammonia, coal, metal, metal hydride, or any combination thereof. In some embodiments, the hydrocarbon fuel is a renewable hydrocarbon fuel.

In some embodiments, the hydrocarbon fuel input into the hydrocarbon reformer (HR) comprises a hydrocarbon gas mixture with a hydrocarbon concentration, relative to the total volume of gases introduced into the reformer, of at least about 30 vol. %, at least about 35 vol. %, at least about 40 vol. %, at least about 45 vol. %, at least about 50 vol. %, at least about 55 vol. %, at least about 60 vol. %, at least about 65 vol. %, at least about 70 vol. %, at least about 75 vol. %, at least about 80 vol. %, at least about 85 vol. %, at least about 90 vol. %, at least about 95 vol. %, or any range or value including and/or in between any two of these values.

In some embodiments, the hydrocarbon fuel input into the HR comprises a hydrocarbon gas mixture with a hydrocarbon concentration of at most about 95 vol. %, at most about 90 vol. %, at most about 85 vol. %, at most about 80 vol. %, at most about 75 vol. %, at most about 70 vol. %, at most about 65 vol. %, at most about 60 vol. %, at most about 55 vol. %, at most about 50 vol. %, at most about 45 vol. %, at most about 40 vol. %, at most about 35 vol. %, at most about 30 vol. %, or any range or value including and/or in between any two of these values.

In some embodiments, the hydrocarbon fuel input into the HR comprises a hydrocarbon gas mixture with a hydrocarbon concentration of about 30 vol. % to about 35 vol. %, about 30 vol. % to about 40 vol. %, about 30 vol. % to about 45 vol. %, about 30 vol. % to about 50 vol. %, about 30 vol. % to about 55 vol. %, about 30 vol. % to about 60 vol. %, about 30 vol. % to about 65 vol. %, about 30 vol. % to about 70 vol. %, about 30 vol. % to about 75 vol. %, about 30 vol. % to about 80 vol. %, about 30 vol. % to about 85 vol. %, about 30 vol. % to about 90 vol. %, about 30 vol. % to about 95 vol. %, about 35 vol. % to about 40 vol. %, about 35 vol. % to about 45 vol. %, about 35 vol. % to about 50 vol. %, about 35 vol. % to about 55 vol. %, about 35 vol. % to about 60 vol. %, about 35 vol. % to about 65 vol. %, about 35 vol. % to about 70 vol. %, about 35 vol. % to about 75 vol. %, about 35 vol. % to about 80 vol. %, about 35 vol. % to about 85 vol. %, about 35 vol. % to about 90 vol. %, about 35 vol. % to about 95 vol. %, about 40 vol. % to about 45 vol. %, about 40 vol. % to about 50 vol. %, about 40 vol. % to about 55 vol. %, about 40 vol. % to about 60 vol. %, about 40 vol. % to about 65 vol. %, about 40 vol. % to about 70 vol. %, about 40 vol. % to about 75 vol. %, about 40 vol. % to about 80 vol. %, about 40 vol. % to about 85 vol. %, about 40 vol. % to about 90 vol. %, about 40 vol. % to about 95 vol. %, about 45 vol. % to about 50 vol. %, about 45 vol. % to about 55 vol. %, about 45 vol. % to about 60 vol. %, about 45 vol. % to about 65 vol. %, about 45 vol. % to about 70 vol. %, about 45 vol. % to about 75 vol. %, about 45 vol. % to about 80 vol. %, about 45 vol. % to about 85 vol. %, about 45 vol. % to about 90 vol. %, about 45 vol. % to about 95 vol. %, about 50 vol. % to about 55 vol. %, about 50 vol. % to about 60 vol. %, about 50 vol. % to about 65 vol. %, about 50 vol. % to about 70 vol. %, about 50 vol. % to about 75 vol. %, about 50 vol. % to about 80 vol. %, about 50 vol. % to about 85 vol. %, about 50 vol. % to about 90 vol. %, about 50 vol. % to about 95 vol. %, about 55 vol. % to about 60 vol. %, about 55 vol. % to about 65 vol. %, about 55 vol. % to about 70 vol. %, about 55 vol. % to about 75 vol. %, about 55 vol. % to about 80 vol. %, about 55 vol. % to about 85 vol. %, about 55 vol. % to about 90 vol. %, about 55 vol. % to about 95 vol. %, about 60 vol. % to about 65 vol. %, about 60 vol. % to about 70 vol. %, about 60 vol. % to about 75 vol. %, about 60 vol. % to about 80 vol. %, about 60 vol. % to about 85 vol. %, about 60 vol. % to about 90 vol. %, about 60 vol. % to about 95 vol. %, about 65 vol. % to about 70 vol. %, about 65 vol. % to about 75 vol. %, about 65 vol. % to about 80 vol. %, about 65 vol. % to about 85 vol. %, about 65 vol. % to about 90 vol. %, about 65 vol. % to about 95 vol. %, about 70 vol. % to about 75 vol. %, about 70 vol. % to about 80 vol. %, about 70 vol. % to about 85 vol. %, about 70 vol. % to about 90 vol. %, about 70 vol. % to about 95 vol. %, about 75 vol. % to about 80 vol. %, about 75 vol. % to about 85 vol. %, about 75 vol. % to about 90 vol. %, about 75 vol. % to about 95 vol. %, about 80 vol. % to about 85 vol. %, about 80 vol. % to about 90 vol. %, about 80 vol. % to about 95 vol. %, about 85 vol. % to about 90 vol. %, about 85 vol. % to about 95 vol. %, or about 90 vol. % to about 95 vol. %.

In some embodiments, the hydrocarbon gas mixture input into the HR further comprises steam (water vapor) with a concentration of at least about 1 vol. %, at least about 2 vol. %, at least about 3 vol. %, at least about 4 vol. %, at least about 5 vol. %, at least about 10 vol. %, at least about 15 vol. %, at least about 20 vol. %, at least about 25 vol. %, at least about 30 vol. %, or any range or value including and/or in between any two of these values..

In some embodiments, the hydrocarbon gas mixture input into the HR further comprises steam (water vapor) with a concentration of less than or equal to about 30 vol. %, less than or equal to about 25 vol. %, less than or equal to about 20 vol. %, less than or equal to about 15 vol. %, less than or equal to about 10 vol. %, less than or equal to about 5 vol. %, less than or equal to about 4 vol. %, less than or equal to about 3 vol. %, less than or equal to about 2 vol. %, less than or equal to about 1 vol. %, or any range or value including and/or in between any two of these values.

In some embodiments, the hydrocarbon gas mixture input into the HR further comprises steam (water vapor) with a concentration of between about 1 vol. % and about 5 vol. %, between about 1 vol. % and about 10 vol. %, between about 1 vol. % and about 15 vol. %, between about 1 vol. % and about 20 vol. %, between about 1 vol. % and about 25 vol. %, between about 1 vol. % and about 30 vol. %, between about 5 vol. % and about 10 vol. %, between about 5 vol. % and about 15 vol. %, between about 5 vol. % and about 20 vol. %, between about 5 vol. % and about 25 vol. %, between about 5 vol. % and about 30 vol. %, between about 10 vol. % and about 15 vol. %, between about 10 vol. % and about 20 vol. %, between about 10 vol. % and about 25 vol. %, between about 10 vol. % and about 30 vol. %, between about 15 vol. % and about 20 vol. %, between about 15 vol. % and about 25 vol. %, between about 15 vol. % and about 30 vol. %, between about 20 vol. % and about 25 vol. %, between about 20 vol. % and about 30 vol. %, between about 25 vol. % and about 30 vol. %, or any range or value therein between.

In some embodiments, the hydrocarbon gas mixture is input into the HR at a pressure of less than or equal to about 5 bar, less than or equal to about 4.5 bar, less than or equal to about 4 bar, less than or equal to about 3.5 bar, less than or equal to about 3 bar, less than or equal to about 2.5 bar, less than or equal to about 2 bar, less than or equal to about 1.5 bar, less than or equal to about 1 bar, less than or equal to about 0.5 bar, or any range or value including and/or in between any two of these values.

In some embodiments, the HR is positioned adjacent to a HR burner. In some embodiments, the hydrocarbon fuel input into the HR burner comprises a hydrocarbon gas mixture with a hydrocarbon concentration of at least about 30 vol. %, at least about 35 vol. %, at least about 40 vol. %, at least about 45 vol. %, at least about 50 vol. %, at least about 55 vol. %, at least about 60 vol. %, at least about 65 vol. %, at least about 70 vol. %, at least about 75 vol. %, at least about 80 vol. %, at least about 85 vol. %, at least about 90 vol. %, at least about 95 vol. %, or any range or value including and/or in between any two of these values. In some embodiments, the remainder of the hydrocarbon gas mixture is substantially oxygen.

In some embodiments, the hydrocarbon fuel input into the HR burner comprises a hydrocarbon gas mixture with a hydrocarbon concentration of at most about 95 vol. %, at most about 90 vol. %, at most about 85 vol. %, at most about 80 vol. %, at most about 75 vol. %, at most about 70 vol. %, at most about 65 vol. %, at most about 60 vol. %, at most about 55 vol. %, at most about 50 vol. %, at most about 45 vol. %, at most about 40 vol. %, at most about 35 vol. %, at most about 30 vol. %, or any range or value including and/or in between any two of these values. In some embodiments, the remainder of the hydrocarbon gas mixture is substantially oxygen.

In some embodiments, the hydrocarbon fuel input into the HR burner comprises a hydrocarbon gas mixture with a hydrocarbon concentration of about 30 vol. % to about 35 vol. %, about 30 vol. % to about 40 vol. %, about 30 vol. % to about 45 vol. %, about 30 vol. % to about 50 vol. %, about 30 vol. % to about 55 vol. %, about 30 vol. % to about 60 vol. %, about 30 vol. % to about 65 vol. %, about 30 vol. % to about 70 vol. %, about 30 vol. % to about 75 vol. %, about 30 vol. % to about 80 vol. %, about 30 vol. % to about 85 vol. %, about 30 vol. % to about 90 vol. %, about 30 vol. % to about 95 vol. %, about 35 vol. % to about 40 vol. %, about 35 vol. % to about 45 vol. %, about 35 vol. % to about 50 vol. %, about 35 vol. % to about 55 vol. %, about 35 vol. % to about 60 vol. %, about 35 vol. % to about 65 vol. %, about 35 vol. % to about 70 vol. %, about 35 vol. % to about 75 vol. %, about 35 vol. % to about 80 vol. %, about 35 vol. % to about 85 vol. %, about 35 vol. % to about 90 vol. %, about 35 vol. % to about 95 vol. %, about 40 vol. % to about 45 vol. %, about 40 vol. % to about 50 vol. %, about 40 vol. % to about 55 vol. %, about 40 vol. % to about 60 vol. %, about 40 vol. % to about 65 vol. %, about 40 vol. % to about 70 vol. %, about 40 vol. % to about 75 vol. %, about 40 vol. % to about 80 vol. %, about 40 vol. % to about 85 vol. %, about 40 vol. % to about 90 vol. %, about 40 vol. % to about 95 vol. %, about 45 vol. % to about 50 vol. %, about 45 vol. % to about 55 vol. %, about 45 vol. % to about 60 vol. %, about 45 vol. % to about 65 vol. %, about 45 vol. % to about 70 vol. %, about 45 vol. % to about 75 vol. %, about 45 vol. % to about 80 vol. %, about 45 vol. % to about 85 vol. %, about 45 vol. % to about 90 vol. %, about 45 vol. % to about 95 vol. %, about 50 vol. % to about 55 vol. %, about 50 vol. % to about 60 vol. %, about 50 vol. % to about 65 vol. %, about 50 vol. % to about 70 vol. %, about 50 vol. % to about 75 vol. %, about 50 vol. % to about 80 vol. %, about 50 vol. % to about 85 vol. %, about 50 vol. % to about 90 vol. %, about 50 vol. % to about 95 vol. %, about 55 vol. % to about 60 vol. %, about 55 vol. % to about 65 vol. %, about 55 vol. % to about 70 vol. %, about 55 vol. % to about 75 vol. %, about 55 vol. % to about 80 vol. %, about 55 vol. % to about 85 vol. %, about 55 vol. % to about 90 vol. %, about 55 vol. % to about 95 vol. %, about 60 vol. % to about 65 vol. %, about 60 vol. % to about 70 vol. %, about 60 vol. % to about 75 vol. %, about 60 vol. % to about 80 vol. %, about 60 vol. % to about 85 vol. %, about 60 vol. % to about 90 vol. %, about 60 vol. % to about 95 vol. %, about 65 vol. % to about 70 vol. %, about 65 vol. % to about 75 vol. %, about 65 vol. % to about 80 vol. %, about 65 vol. % to about 85 vol. %, about 65 vol. % to about 90 vol. %, about 65 vol. % to about 95 vol. %, about 70 vol. % to about 75 vol. %, about 70 vol. % to about 80 vol. %, about 70 vol. % to about 85 vol. %, about 70 vol. % to about 90 vol. %, about 70 vol. % to about 95 vol. %, about 75 vol. % to about 80 vol. %, about 75 vol. % to about 85 vol. %, about 75 vol. % to about 90 vol. %, about 75 vol. % to about 95 vol. %, about 80 vol. % to about 85 vol. %, about 80 vol. % to about 90 vol. %, about 80 vol. % to about 95 vol. %, about 85 vol. % to about 90 vol. %, about 85 vol. % to about 95 vol. %, or about 90 vol. % to about 95 vol. %.

In some embodiment, the HR burner heats the hydrocarbon gas mixture to a temperature of at least about 500° C., at least about 525° C., at least about 550° C., at least about 575° C., at least about 600° C., at least about 625° C., at least about 650° C., at least about 675° C., at least about 700° C., at least about 725° C., at least about 750° C., at least about 775° C., at least about 800° C., at least about 825° C., at least about 850° C., at least about 875° C., at least about 900° C., at least about 925° C., at least about 950° C., at least about 975° C., at least about 1000° C., at least about 1025° C., at least about 1050° C., at least about 1075° C., at least about 1100° C., at least about 1125° C., at least about 1150° C., at least about 1175° C., at least about 1200° C., at least about 1225° C., at least about 1250° C., at least about 1275° C., at least about 1300° C., at least about 1325° C., at least about 1350° C., at least about 1375° C., at least about 1400° C., at least about 1425° C., at least about 1450° C., at least about 1475° C., or at least about 1500° C.

In some embodiment, the HR burner heats the hydrocarbon gas mixture to a temperature of at most about 1500° C., at most about 1475° C., at most about 1450° C., at most about 1425° C., at most about 1400° C., at most about 1375° C., at most about 1350° C., at most about 1325° C., at most about 1300° C., at most about 1275° C., at most about 1250° C., at most about 1225° C., at most about 1200° C., at most about 1175° C., at most about 1150° C., at most about 1125° C., at most about 1100° C., at most about 1075° C., at most about 1050° C., at most about 1025° C., at most about 1000° C., at most about 975° C., at most about 950° C., at most about 925° C., at most about 900° C., at most about 875° C., at most about 850° C., at most about 825° C., at most about 800° C., at most about 775° C., at most about 750° C., at most about 725° C., at most about 700° C., at most about 675° C., at most about 650° C., at most about 625° C., at most about 600° C., at most about 575° C., at most about 550° C., at most about 525° C., or at most about 500° C.

In some embodiment, the HR burner heats the hydrocarbon gas mixture to a temperature of between about 500° C. and about 600° C., between about 500° C. and about 700° C., between about 500° C. and about 800° C., between about 500° C. and about 900° C., between about 500° C. and about 1000° C., between about 500° C. and about 1100° C., between about 500° C. and about 1200° C., between about 500° C. and about 1300° C., between about 500° C. and about 1400° C., between about 500° C. and about 1500° C., between about 600° C. and about 700° C., between about 600° C. and about 800° C., between about 600° C. and about 900° C., between about 600° C. and about 1000° C., between about 600° C. and about 1100° C., between about 600° C. and about 1200° C., between about 600° C. and about 1300° C., between about 600° C. and about 1400° C., between about 600° C. and about 1500° C., between about 700° C. and about 800° C., between about 700° C. and about 900° C., between about 700° C. and about 1000° C., between about 700° C. and about 1100° C., between about 700° C. and about 1200° C., between about 700° C. and about 1300° C., between about 700° C. and about 1400° C., between about 700° C. and about 1500° C., between about 800° C. and about 900° C., between about 800° C. and about 1000° C., between about 800° C. and about 1100° C., between about 800° C. and about 1200° C., between about 800° C. and about 1300° C., between about 800° C. and about 1400° C., between about 800° C. and about 1500° C., between about 900° C. and about 1000° C., between about 900° C. and about 1100° C., between about 900° C. and about 1200° C., between about 900° C. and about 1300° C., between about 900° C. and about 1400° C., between about 900° C. and about 1500° C., between about 1000° C. and about 1100° C., between about 1000° C. and about 1200° C., between about 1000° C. and about 1300° C., between about 1000° C. and about 1400° C., between about 1000° C. and about 1500° C., between about 1100° C. and about 1200° C., between about 1100° C. and about 1300° C., between about 1100° C. and about 1400° C., between about 1100° C. and about 1500° C., between about 1200° C. and about 1300° C., between about 1200° C. and about 1400° C., between about 1200° C. and about 1500° C., between about 1300° C. and about 1400° C., between about 1300° C. and about 1500° C., between about 1400° C. and about 1500° C., or any range or value therein between.

In some embodiment, the HR burner heats the hydrocarbon gas mixture to a pressure of at least about 1 bar, at least about 2 bar, at least about 3 bar, at least about 4 bar, at least about 5 bar, at least about 10 bar, at least about 15 bar, at least about 20 bar, at least about 25 bar, at least about 30 bar, or any range or value including and/or in between any two of these values.

In some embodiment, the HR burner heats the hydrocarbon gas mixture to a pressure of less than or equal to about 30 bar, less than or equal to about 25 bar, less than or equal to about 20 bar, less than or equal to about 15 bar, less than or equal to about 10 bar, less than or equal to about 5 bar, less than or equal to about 4 bar, less than or equal to about 3 bar, less than or equal to about 2 bar, less than or equal to about 1 bar, or any range or value including and/or in between any two of these values.

In some embodiment, the HR burner heats the hydrocarbon gas mixture to a pressure of between about 1 bar and about 4 bar, between about 1 bar and about 5 bar, between about 1 bar and about 10 bar, between about 1 bar and about 15 bar, between about 1 bar and about 20 bar, between about 1 bar and about 25 bar, between about 1 bar and about 30 bar, between about 2 bar and about 3 bar, between about 2 bar and about 4 bar, between about 2 bar and about 5 bar, between about 2 bar and about 10 bar, between about 2 bar and about 15 bar, between about 2 bar and about 20 bar, between about 2 bar and about 25 bar, between about 2 bar and about 30 bar, between about 3 bar and about 4 bar, between about 3 bar and about 5 bar, between about 3 bar and about 10 bar, between about 3 bar and about 15 bar, between about 3 bar and about 20 bar, between about 3 bar and about 25 bar, between about 3 bar and about 30 bar, between about 4 bar and about 5 bar, between about 4 bar and about 10 bar, between about 4 bar and about 15 bar, between about 4 bar and about 20 bar, between about 4 bar and about 25 bar, between about 4 bar and about 30 bar, between about 5 bar and about 10 bar, between about 5 bar and about 15 bar, between about 5 bar and about 20 bar, between about 5 bar and about 25 bar, between about 5 bar and about 30 bar, between about 10 bar and about 15 bar, between about 10 bar and about 20 bar, between about 10 bar and about 25 bar, between about 10 bar and about 30 bar, between about 15 bar and about 20 bar, between about 15 bar and about 25 bar, between about 15 bar and about 30 bar, between about 20 bar and about 25 bar, between about 20 bar and about 30 bar, between about 25 bar and about 30 bar, or any range or value therein between.

In some embodiments, the HR comprises a catalyst. In some embodiments, the catalyst is a nickel-based catalyst, an iron-based catalyst, or a platinum group metal (PGM)-based catalyst, such as platinum (Pt), ruthenium (Ru), rhodium (Rh), palladium (Pd), osmium (Os), and iridium (Ir), as well as other metals, such as silver (Ag), gold (Au), or rhenium (Re), as well as an alloy or other multi-element material including one or more of the foregoing.

In some embodiments, the HR is a steam methane reformer (SMR), a fluidized-bed reactor, a plasma reactor, or a catalytic reactor.

In some embodiments, the HR outputs a carbon oxides and hydrogen gas product (e.g., syngas). In some embodiments, the carbon oxides and hydrogen gas product comprises hydrogen at a concentration of at least about 30 vol. %, at least about 35 vol. %, at least about 40 vol. %, at least about 45 vol. %, at least about 50 vol. %, at least about 55 vol. %, at least about 60 vol. %, at least about 65 vol. %, at least about 70 vol. %, at least about 75 vol. %, at least about 80 vol. %, at least about 85 vol. %, at least about 90 vol. %, at least about 95 vol. %, or any range or value including and/or in between any two of these values. In some embodiments, the remainder of the gas product is substantially carbon oxides.

In some embodiments, the carbon oxides and hydrogen gas product comprises hydrogen at a concentration of at most about 95 vol. %, at most about 90 vol. %, at most about 85 vol. %, at most about 80 vol. %, at most about 75 vol. %, at most about 70 vol. %, at most about 65 vol. %, at most about 60 vol. %, at most about 55 vol. %, at most about 50 vol. %, at most about 45 vol. %, at most about 40 vol. %, at most about 35 vol. %, at most about 30 vol. %, or any range or value including and/or in between any two of these values. In some embodiments, the remainder of the hydrocarbon gas mixture is substantially carbon oxides.

In some embodiments, the carbon oxides and hydrogen gas product comprises hydrogen at a concentration of about 30 vol. % to about 35 vol. %, about 30 vol. % to about 40 vol. %, about 30 vol. % to about 45 vol. %, about 30 vol. % to about 50 vol. %, about 30 vol. % to about 55 vol. %, about 30 vol. % to about 60 vol. %, about 30 vol. % to about 65 vol. %, about 30 vol. % to about 70 vol. %, about 30 vol. % to about 75 vol. %, about 30 vol. % to about 80 vol. %, about 30 vol. % to about 85 vol. %, about 30 vol. % to about 90 vol. %, about 30 vol. % to about 95 vol. %, about 35 vol. % to about 40 vol. %, about 35 vol. % to about 45 vol. %, about 35 vol. % to about 50 vol. %, about 35 vol. % to about 55 vol. %, about 35 vol. % to about 60 vol. %, about 35 vol. % to about 65 vol. %, about 35 vol. % to about 70 vol. %, about 35 vol. % to about 75 vol. %, about 35 vol. % to about 80 vol. %, about 35 vol. % to about 85 vol. %, about 35 vol. % to about 90 vol. %, about 35 vol. % to about 95 vol. %, about 40 vol. % to about 45 vol. %, about 40 vol. % to about 50 vol. %, about 40 vol. % to about 55 vol. %, about 40 vol. % to about 60 vol. %, about 40 vol. % to about 65 vol. %, about 40 vol. % to about 70 vol. %, about 40 vol. % to about 75 vol. %, about 40 vol. % to about 80 vol. %, about 40 vol. % to about 85 vol. %, about 40 vol. % to about 90 vol. %, about 40 vol. % to about 95 vol. %, about 45 vol. % to about 50 vol. %, about 45 vol. % to about 55 vol. %, about 45 vol. % to about 60 vol. %, about 45 vol. % to about 65 vol. %, about 45 vol. % to about 70 vol. %, about 45 vol. % to about 75 vol. %, about 45 vol. % to about 80 vol. %, about 45 vol. % to about 85 vol. %, about 45 vol. % to about 90 vol. %, about 45 vol. % to about 95 vol. %, about 50 vol. % to about 55 vol. %, about 50 vol. % to about 60 vol. %, about 50 vol. % to about 65 vol. %, about 50 vol. % to about 70 vol. %, about 50 vol. % to about 75 vol. %, about 50 vol. % to about 80 vol. %, about 50 vol. % to about 85 vol. %, about 50 vol. % to about 90 vol. %, about 50 vol. % to about 95 vol. %, about 55 vol. % to about 60 vol. %, about 55 vol. % to about 65 vol. %, about 55 vol. % to about 70 vol. %, about 55 vol. % to about 75 vol. %, about 55 vol. % to about 80 vol. %, about 55 vol. % to about 85 vol. %, about 55 vol. % to about 90 vol. %, about 55 vol. % to about 95 vol. %, about 60 vol. % to about 65 vol. %, about 60 vol. % to about 70 vol. %, about 60 vol. % to about 75 vol. %, about 60 vol. % to about 80 vol. %, about 60 vol. % to about 85 vol. %, about 60 vol. % to about 90 vol. %, about 60 vol. % to about 95 vol. %, about 65 vol. % to about 70 vol. %, about 65 vol. % to about 75 vol. %, about 65 vol. % to about 80 vol. %, about 65 vol. % to about 85 vol. %, about 65 vol. % to about 90 vol. %, about 65 vol. % to about 95 vol. %, about 70 vol. % to about 75 vol. %, about 70 vol. % to about 80 vol. %, about 70 vol. % to about 85 vol. %, about 70 vol. % to about 90 vol. %, about 70 vol. % to about 95 vol. %, about 75 vol. % to about 80 vol. %, about 75 vol. % to about 85 vol. %, about 75 vol. % to about 90 vol. %, about 75 vol. % to about 95 vol. %, about 80 vol. % to about 85 vol. %, about 80 vol. % to about 90 vol. %, about 80 vol. % to about 95 vol. %, about 85 vol. % to about 90 vol. %, about 85 vol. % to about 95 vol. %, or about 90 vol. % to about 95 vol. %.

In some embodiments, the carbon oxides and hydrogen gas product produced by the HR exits the HR at a pressure of less than or equal to about 3 bar, less than or equal to about 2.5 bar, less than or equal to about 2 bar, less than or equal to about 1.5 bar, less than or equal to about 1 bar, less than or equal to about 0.5 bar, or any range or value including and/or in between any two of these values.

In some embodiments, the HR receives water from a hydrogen distribution device at a rate of at least about 1 mL/s, at least about 2 mL/s, at least about 3 mL/s, at least about 4 mL/s, at least about 5 mL/s, at least about 10 mL/s, at least about 20 mL/s, at least about 30 mL/s, at least about 40 mL/s, at least about 50 mL/s, at least about 100 mL/s, at least about 200 mL/s, at least about 300 mL/s, at least about 400 mL/s, at least about 500 mL/s, at least about 1000 mL/s, at least about 1500 mL/s, at least about 2000 mL/s, at least about 2500 mL/s, at least about 3000 mL/s, at least about 3500 mL/s, at least about 4000 mL/s, or any range or value including and/or in between any two of these values.

In some embodiments, the HR receives water from a hydrogen distribution device at a rate of less than or equal to about 4000 mL/s, less than or equal to about 3500 mL/s, less than or equal to about 3000 mL/s, less than or equal to about 2500 mL/s, less than or equal to about 2000 mL/s, less than or equal to about 1500 mL/s, less than or equal to about 1000 mL/s, less than or equal to about 500 mL/s, less than or equal to about 400 mL/s, less than or equal to about 300 mL/s, less than or equal to about 200 mL/s, less than or equal to about 100 mL/s, less than or equal to about 50 mL/s, less than or equal to about 40 mL/s, less than or equal to about 30 mL/s, less than or equal to about 20 mL/s, less than or equal to about 10 mL/s, less than or equal to about 5 mL/s, less than or equal to about 4 mL/s, or any range or value including and/or in between any two of these values.

In some embodiments, the HR receives water from a hydrogen distribution device at a rate of between about 1 mL/s and about 5 mL/s, between about 1 mL/s and about 10 mL/s, between about 1 mL/s and about 50 mL/s, between about 1 mL/s and about 100 mL/s, between about 1 mL/s and about 500 mL/s, between about 1 mL/s and about 1000 mL/s, between about 1 mL/s and about 2000 mL/s, between about 1 mL/s and about 3000 mL/s, between about 1 mL/s and about 4000 mL/s, between about 5 mL/s and about 10 mL/s, between about 5 mL/s and about 50 mL/s, between about 5 mL/s and about 100 mL/s, between about 5 mL/s and about 500 mL/s, between about 5 mL/s and about 1000 mL/s, between about 5 mL/s and about 2000 mL/s, between about 5 mL/s and about 3000 mL/s, between about 5 mL/s and about 4000 mL/s, between about 10 mL/s and about 50 mL/s, between about 10 mL/s and about 100 mL/s, between about 10 mL/s and about 500 mL/s, between about 10 mL/s and about 1000 mL/s, between about 10 mL/s and about 2000 mL/s, between about 10 mL/s and about 3000 mL/s, between about 10 mL/s and about 4000 mL/s, between about 50 mL/s and about 100 mL/s, between about 50 mL/s and about 500 mL/s, between about 50 mL/s and about 1000 mL/s, between about 50 mL/s and about 2000 mL/s, between about 50 mL/s and about 3000 mL/s, between about 50 mL/s and about 4000 mL/s, between about 100 mL/s and about 500 mL/s, between about 100 mL/s and about 1000 mL/s, between about 100 mL/s and about 2000 mL/s, between about 100 mL/s and about 3000 mL/s, between about 100 mL/s and about 4000 mL/s, between about 500 mL/s and about 1000 mL/s, between about 500 mL/s and about 2000 mL/s, between about 500 mL/s and about 3000 mL/s, between about 500 mL/s and about 4000 mL/s, between about 1000 mL/s and about 2000 mL/s, between about 1000 mL/s and about 3000 mL/s, between about 1000 mL/s and about 4000 mL/s, between about 2000 mL/s and about 3000 mL/s, between about 2000 mL/s and about 4000 mL/s, between about 3000 mL/s and about 4000 mL/s, or any range or value therein between.

In some embodiments, the HR burner receives a hydrogen-depleted syngas from a hydrogen distribution device having a hydrogen concentration of at least about 10 vol. %, at least about 20 vol. %, at least about 30 vol. %, at least about 40 vol. %, at least about 50 vol. %, at least about 60 vol. %, or any range or value including and/or in between any two of these values. In some embodiments, the remainder of the hydrogen-depleted syngas is substantially carbon oxides.

In some embodiments, the HR burner receives a hydrogen-depleted syngas having a hydrogen concentration of less than or equal to about 60 vol. %, less than or equal to about 50 vol. %, less than or equal to about 40 vol. %, less than or equal to about 30 vol. %, less than or equal to about 20 vol. %, less than or equal to about 10 vol. %, or any range or value including and/or in between any two of these values. In some embodiments, the remainder of the hydrogen-depleted syngas is substantially carbon oxides.

In some embodiments, the HR burner receives a hydrogen-depleted syngas having a hydrogen concentration of between about 10 vol. % and about 20 vol. %, between about 10 vol. % and about 30 vol. %, between about 10 vol. % and about 40 vol. %, between about 10 vol. % and about 50 vol. %, between about 10 vol. % and about 60 vol. %, between about 20 vol. % and about 30 vol. %, between about 20 vol. % and about 40 vol. %, between about 20 vol. % and about 50 vol. %, between about 20 vol. % and about 60 vol. %, between about 30 vol. % and about 40 vol. %, between about 30 vol. % and about 50 vol. %, between about 30 vol. % and about 60 vol. %, between about 40 vol. % and about 50 vol. %, between about 40 vol. % and about 60 vol. %, between about 50 vol. % and about 60 vol. %, or any range or value therein between.

### Fuel Cells

A hydrogen distribution device according to the present disclosure comprises a plurality of fuel cells capable of producing electricity using hydrogen in an electricity production mode or producing hydrogen in a hydrogen product mode. In some embodiments, the plurality of fuel cells comprises polymer electrolyte membrane fuel cells (“PEMFCs”), molten carbonate fuel cells (“MCFCs”), or solid oxide fuel cells (“SOFCs”). In some embodiments, the fuel cell is an alkaline fuel cell, a phosphoric acid fuel cell, or a direct methanol fuel cell. In some embodiments, the fuel cells are PEMFCs.

A PEMFC converts chemical energy into electrical energy by the reaction of hydrogen with oxygen. A PEMFC comprises an anode, a cathode, and a proton-conducting electrolyte membrane, which facilitates electrochemical reaction of hydrogen with oxygen to produce water. The fundamental working principle involves the separation of hydrogen molecules into protons and electrons, with protons passing through the electrolyte membrane and electrons generating electrical current via an external circuit.

The anode is the electrode where hydrogen gas is supplied. It is typically made of a conductive material such as carbon combined with a catalyst (often platinum) to facilitate the splitting of hydrogen molecules.

The cathode is the electrode where oxygen from the air is introduced. It is similarly composed of conductive materials, often with a platinum-based catalyst, which assists in the reduction of oxygen and the subsequent formation of water.

The PEM is a proton-conducting membrane that allows hydrogen ions (protons) to pass through but blocks electrons. This selective ion conductivity is crucial for the operation of the fuel cell.

The flow field plates distribute the reactant gases (hydrogen and oxygen), remove byproducts, and help in the thermal management of the fuel cell.

To operate the fuel cell, a gas comprising hydrogen is introduced into the anode side of the fuel cell. At the anode, a catalyst splits the hydrogen molecules into protons and electrons. The protons pass through the proton-conducting electrolyte membrane, while the electrons flow through an external circuit, generating electrical current. Meanwhile, oxygen is supplied to the cathode side. The protons that passed through the electrolyte membrane, along with the electrons that traveled through the external circuit, react with oxygen at the cathode. The catalyst at the cathode facilitates the reduction of oxygen, and forms water as a byproduct, which is expelled from the fuel cell via a cathode outlet.

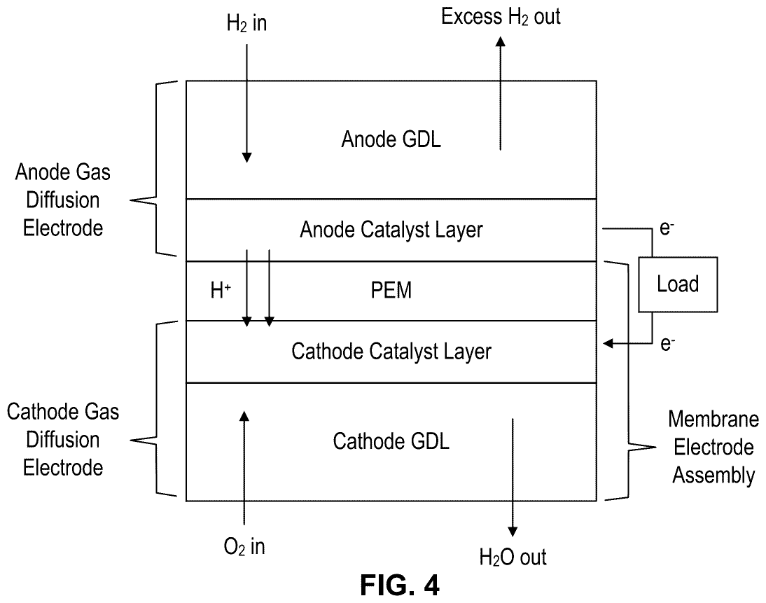

Referring now to FIG. 4, PEMFCs are constructed from membrane electrolyte assemblies (“MEAs”), which are in turn constructed from a proton-conducting PEM in contact with a catalyst layer. MEAs according to the present disclosure may correspond to the cathode side and/or the anode side of an electrochemical device (e.g., fuel cell). The catalyst layer (anode or cathode) is interposed between a gas diffusion layer (“GDL”) and the PEM. The GDL layers permit gas-phase reactants (e.g., oxygen, hydrogen, etc.) to diffuse into the catalyst layers (e.g., of the anode and/or cathode) (e.g., platinum, etc.), where the anode or cathode cell reactions occur. Thus, the interface between the gas diffusion layer and the catalyst layer limits the rate at which gas phase reactants can enter the catalyst layer, participate in the cell reactions, and drive current flow through (and voltage across) the electrochemical device (e.g., fuel cell).

By way of non-limiting example, the catalyst layer according to the present disclosure is not particularly limited. In some embodiments, the catalyst comprises a platinum group metal (PGM), such as platinum (Pt), ruthenium (Ru), rhodium (Rh), palladium (Pd), osmium (Os), and iridium (Ir), as well as other metals, such as silver (Ag), gold (Au), or rhenium (Re), as well as an alloy or other multi-element material including one or more of the foregoing.

In some embodiments, a hydrogen distribution device comprises a plurality of fuel cells. In some embodiments, the hydrogen distribution device comprises at least 2 fuel cells (e.g., 2, 3, 4, 5, 6, 7, 8 9, 10, 15, 20, 25, 30, 35, 40, 45, 50, or more fuel cells). There is no theoretical upper limit on the number of fuel cells that may be used in a hydrogen distribution device according to the present disclosure. However, practical considerations (space, cost, etc.) may limit the number of fuel cells to less than 20 or less than 10 (e.g., about 3, 4, or 5 fuel cells).

In some embodiments, a fuel cell anode-side inlet receives a carbon oxides and hydrogen gas product (e.g., syngas) at a pressure of less than or equal to about 3 bar, less than or equal to about 2.5 bar, less than or equal to about 2 bar, less than or equal to about 1.5 bar, less than or equal to about 1 bar, less than or equal to about 0.5 bar, or any range or value including and/or in between any two of these values.

In some embodiments, the carbon oxides and hydrogen gas product has a hydrogen concentration of at least about 30 vol. %, at least about 35 vol. %, at least about 40 vol. %, at least about 45 vol. %, at least about 50 vol. %, at least about 55 vol. %, at least about 60 vol. %, at least about 65 vol. %, at least about 70 vol. %, at least about 75 vol. %, at least about 80 vol. %, at least about 85 vol. %, at least about 90 vol. %, at least about 95 vol. %, or any range or value including and/or in between any two of these values. In some embodiments, the remainder of the gas product is substantially carbon oxides.

In some embodiments, the carbon oxides and hydrogen gas product has a hydrogen concentration of at most about 95 vol. %, at most about 90 vol. %, at most about 85 vol. %, at most about 80 vol. %, at most about 75 vol. %, at most about 70 vol. %, at most about 65 vol. %, at most about 60 vol. %, at most about 55 vol. %, at most about 50 vol. %, at most about 45 vol. %, at most about 40 vol. %, at most about 35 vol. %, at most about 30 vol. %, or any range or value including and/or in between any two of these values. In some embodiments, the remainder of the gas product is substantially carbon oxides.

In some embodiments, the carbon oxides and hydrogen gas product has a hydrogen concentration of about 30 vol. % to about 35 vol. %, about 30 vol. % to about 40 vol. %, about 30 vol. % to about 45 vol. %, about 30 vol. % to about 50 vol. %, about 30 vol. % to about 55 vol. %, about 30 vol. % to about 60 vol. %, about 30 vol. % to about 65 vol. %, about 30 vol. % to about 70 vol. %, about 30 vol. % to about 75 vol. %, about 30 vol. % to about 80 vol. %, about 30 vol. % to about 85 vol. %, about 30 vol. % to about 90 vol. %, about 30 vol. % to about 95 vol. %, about 35 vol. % to about 40 vol. %, about 35 vol. % to about 45 vol. %, about 35 vol. % to about 50 vol. %, about 35 vol. % to about 55 vol. %, about 35 vol. % to about 60 vol. %, about 35 vol. % to about 65 vol. %, about 35 vol. % to about 70 vol. %, about 35 vol. % to about 75 vol. %, about 35 vol. % to about 80 vol. %, about 35 vol. % to about 85 vol. %, about 35 vol. % to about 90 vol. %, about 35 vol. % to about 95 vol. %, about 40 vol. % to about 45 vol. %, about 40 vol. % to about 50 vol. %, about 40 vol. % to about 55 vol. %, about 40 vol. % to about 60 vol. %, about 40 vol. % to about 65 vol. %, about 40 vol. % to about 70 vol. %, about 40 vol. % to about 75 vol. %, about 40 vol. % to about 80 vol. %, about 40 vol. % to about 85 vol. %, about 40 vol. % to about 90 vol. %, about 40 vol. % to about 95 vol. %, about 45 vol. % to about 50 vol. %, about 45 vol. % to about 55 vol. %, about 45 vol. % to about 60 vol. %, about 45 vol. % to about 65 vol. %, about 45 vol. % to about 70 vol. %, about 45 vol. % to about 75 vol. %, about 45 vol. % to about 80 vol. %, about 45 vol. % to about 85 vol. %, about 45 vol. % to about 90 vol. %, about 45 vol. % to about 95 vol. %, about 50 vol. % to about 55 vol. %, about 50 vol. % to about 60 vol. %, about 50 vol. % to about 65 vol. %, about 50 vol. % to about 70 vol. %, about 50 vol. % to about 75 vol. %, about 50 vol. % to about 80 vol. %, about 50 vol. % to about 85 vol. %, about 50 vol. % to about 90 vol. %, about 50 vol. % to about 95 vol. %, about 55 vol. % to about 60 vol. %, about 55 vol. % to about 65 vol. %, about 55 vol. % to about 70 vol. %, about 55 vol. % to about 75 vol. %, about 55 vol. % to about 80 vol. %, about 55 vol. % to about 85 vol. %, about 55 vol. % to about 90 vol. %, about 55 vol. % to about 95 vol. %, about 60 vol. % to about 65 vol. %, about 60 vol. % to about 70 vol. %, about 60 vol. % to about 75 vol. %, about 60 vol. % to about 80 vol. %, about 60 vol. % to about 85 vol. %, about 60 vol. % to about 90 vol. %, about 60 vol. % to about 95 vol. %, about 65 vol. % to about 70 vol. %, about 65 vol. % to about 75 vol. %, about 65 vol. % to about 80 vol. %, about 65 vol. % to about 85 vol. %, about 65 vol. % to about 90 vol. %, about 65 vol. % to about 95 vol. %, about 70 vol. % to about 75 vol. %, about 70 vol. % to about 80 vol. %, about 70 vol. % to about 85 vol. %, about 70 vol. % to about 90 vol. %, about 70 vol. % to about 95 vol. %, about 75 vol. % to about 80 vol. %, about 75 vol. % to about 85 vol. %, about 75 vol. % to about 90 vol. %, about 75 vol. % to about 95 vol. %, about 80 vol. % to about 85 vol. %, about 80 vol. % to about 90 vol. %, about 80 vol. % to about 95 vol. %, about 85 vol. % to about 90 vol. %, about 85 vol. % to about 95 vol. %, or about 90 vol. % to about 95 vol. %.

In some embodiments, a fuel cell anode-side outlet outputs a hydrogen-depleted syngas comprising hydrogen at a concentration of at least about 10 vol. %, at least about 20 vol. %, at least about 30 vol. %, at least about 40 vol. %, at least about 50 vol. %, at least about 60 vol. %, at least about 70 vol. %, or any range or value including and/or in between any two of these values. In some embodiments, the remainder of the gas product is substantially carbon oxides.

In some embodiments, the fuel cell anode-side outlet outputs a hydrogen-depleted syngas comprising a hydrogen concentration of less than or equal to about 70 vol. %, less than or equal to about 60 vol. %, less than or equal to about 50 vol. %, less than or equal to about 40 vol. %, less than or equal to about 30 vol. %, less than or equal to about 20 vol. %, less than or equal to about 10 vol. %, or any range or value including and/or in between any two of these values. In some embodiments, the remainder of the gas product is substantially carbon oxides.

In some embodiments, the fuel cell anode-side outlet outputs a hydrogen-depleted syngas comprising a hydrogen concentration of between about 10 vol. % and about 20 vol. %, between about 10 vol. % and about 30 vol. %, between about 10 vol. % and about 40 vol. %, between about 10 vol. % and about 50 vol. %, between about 10 vol. % and about 60 vol. %, between about 10 vol. % and about 70 vol. %, between about 20 vol. % and about 30 vol. %, between about 20 vol. % and about 40 vol. %, between about 20 vol. % and about 50 vol. %, between about 20 vol. % and about 60 vol. %, between about 20 vol. % and about 70 vol. %, between about 30 vol. % and about 40 vol. %, between about 30 vol. % and about 50 vol. %, between about 30 vol. % and about 60 vol. %, between about 30 vol. % and about 70 vol. %, between about 40 vol. % and about 50 vol. %, between about 40 vol. % and about 60 vol. %, between about 40 vol. % and about 70 vol. %, between about 50 vol. % and about 60 vol. %, between about 50 vol. % and about 70 vol. %, between about 60 vol. % and about 70 vol. %, or any range or value therein between.

In some embodiments, a fuel cell cathode-side outlet outputs a substantially pure hydrogen gas (e.g., a hydrogen gas having a purity of at least about 95%, at least about 96%, at least about 97%, at least about 98%, at least about 99%, at least about 99.5%, or greater).

In some embodiments, the substantially pure hydrogen gas dilutes a syngas at a fuel cell anode-side. In some embodiments, the hydrogen-diluted syngas has a hydrogen concentration of at least about 30 vol. %, at least about 35 vol. %, at least about 40 vol. %, at least about 45 vol. %, at least about 50 vol. %, at least about 55 vol. %, at least about 60 vol. %, at least about 65 vol. %, at least about 70 vol. %, at least about 75 vol. %, at least about 80 vol. %, at least about 85 vol. %, at least about 90 vol. %, at least about 95 vol. %, or any range or value including and/or in between any two of these values. In some embodiments, the remainder of the gas product is substantially carbon oxides.

In some embodiments, the hydrogen-diluted syngas has a hydrogen concentration of at most about 95 vol. %, at most about 90 vol. %, at most about 85 vol. %, at most about 80 vol. %, at most about 75 vol. %, at most about 70 vol. %, at most about 65 vol. %, at most about 60 vol. %, at most about 55 vol. %, at most about 50 vol. %, at most about 45 vol. %, at most about 40 vol. %, at most about 35 vol. %, at most about 30 vol. %, or any range or value including and/or in between any two of these values. In some embodiments, the remainder of the gas product is substantially carbon oxides.

In some embodiments, the hydrogen-diluted syngas has a hydrogen concentration of about 30 vol. % to about 35 vol. %, about 30 vol. % to about 40 vol. %, about 30 vol. % to about 45 vol. %, about 30 vol. % to about 50 vol. %, about 30 vol. % to about 55 vol. %, about 30 vol. % to about 60 vol. %, about 30 vol. % to about 65 vol. %, about 30 vol. % to about 70 vol. %, about 30 vol. % to about 75 vol. %, about 30 vol. % to about 80 vol. %, about 30 vol. % to about 85 vol. %, about 30 vol. % to about 90 vol. %, about 30 vol. % to about 95 vol. %, about 35 vol. % to about 40 vol. %, about 35 vol. % to about 45 vol. %, about 35 vol. % to about 50 vol. %, about 35 vol. % to about 55 vol. %, about 35 vol. % to about 60 vol. %, about 35 vol. % to about 65 vol. %, about 35 vol. % to about 70 vol. %, about 35 vol. % to about 75 vol. %, about 35 vol. % to about 80 vol. %, about 35 vol. % to about 85 vol. %, about 35 vol. % to about 90 vol. %, about 35 vol. % to about 95 vol. %, about 40 vol. % to about 45 vol. %, about 40 vol. % to about 50 vol. %, about 40 vol. % to about 55 vol. %, about 40 vol. % to about 60 vol. %, about 40 vol. % to about 65 vol. %, about 40 vol. % to about 70 vol. %, about 40 vol. % to about 75 vol. %, about 40 vol. % to about 80 vol. %, about 40 vol. % to about 85 vol. %, about 40 vol. % to about 90 vol. %, about 40 vol. % to about 95 vol. %, about 45 vol. % to about 50 vol. %, about 45 vol. % to about 55 vol. %, about 45 vol. % to about 60 vol. %, about 45 vol. % to about 65 vol. %, about 45 vol. % to about 70 vol. %, about 45 vol. % to about 75 vol. %, about 45 vol. % to about 80 vol. %, about 45 vol. % to about 85 vol. %, about 45 vol. % to about 90 vol. %, about 45 vol. % to about 95 vol. %, about 50 vol. % to about 55 vol. %, about 50 vol. % to about 60 vol. %, about 50 vol. % to about 65 vol. %, about 50 vol. % to about 70 vol. %, about 50 vol. % to about 75 vol. %, about 50 vol. % to about 80 vol. %, about 50 vol. % to about 85 vol. %, about 50 vol. % to about 90 vol. %, about 50 vol. % to about 95 vol. %, about 55 vol. % to about 60 vol. %, about 55 vol. % to about 65 vol. %, about 55 vol. % to about 70 vol. %, about 55 vol. % to about 75 vol. %, about 55 vol. % to about 80 vol. %, about 55 vol. % to about 85 vol. %, about 55 vol. % to about 90 vol. %, about 55 vol. % to about 95 vol. %, about 60 vol. % to about 65 vol. %, about 60 vol. % to about 70 vol. %, about 60 vol. % to about 75 vol. %, about 60 vol. % to about 80 vol. %, about 60 vol. % to about 85 vol. %, about 60 vol. % to about 90 vol. %, about 60 vol. % to about 95 vol. %, about 65 vol. % to about 70 vol. %, about 65 vol. % to about 75 vol. %, about 65 vol. % to about 80 vol. %, about 65 vol. % to about 85 vol. %, about 65 vol. % to about 90 vol. %, about 65 vol. % to about 95 vol. %, about 70 vol. % to about 75 vol. %, about 70 vol. % to about 80 vol. %, about 70 vol. % to about 85 vol. %, about 70 vol. % to about 90 vol. %, about 70 vol. % to about 95 vol. %, about 75 vol. % to about 80 vol. %, about 75 vol. % to about 85 vol. %, about 75 vol. % to about 90 vol. %, about 75 vol. % to about 95 vol. %, about 80 vol. % to about 85 vol. %, about 80 vol. % to about 90 vol. %, about 80 vol. % to about 95 vol. %, about 85 vol. % to about 90 vol. %, about 85 vol. % to about 95 vol. %, or about 90 vol. % to about 95 vol. %.

In some embodiments, a water pump extracts water from a fuel cell cathode-side outlet. In some embodiments, the water is extracted at a rate of at least about 1 mL/s, at least about 2 mL/s, at least about 3 mL/s, at least about 4 mL/s, at least about 5 mL/s, at least about 10 mL/s, at least about 20 mL/s, at least about 30 mL/s, at least about 40 mL/s, at least about 50 mL/s, at least about 100 mL/s, at least about 200 mL/s, at least about 300 mL/s, at least about 400 mL/s, at least about 500 mL/s, at least about 1000 mL/s, at least about 1500 mL/s, at least about 2000 mL/s, at least about 2500 mL/s, at least about 3000 mL/s, at least about 3500 mL/s, at least about 4000 mL/s, or any range or value including and/or in between any two of these values.

In some embodiments, the water is extracted at a rate of less than or equal to about 4000 mL/s, less than or equal to about 3500 mL/s, less than or equal to about 3000 mL/s, less than or equal to about 2500 mL/s, less than or equal to about 2000 mL/s, less than or equal to about 1500 mL/s, less than or equal to about 1000 mL/s, less than or equal to about 500 mL/s, less than or equal to about 400 mL/s, less than or equal to about 300 mL/s, less than or equal to about 200 mL/s, less than or equal to about 100 mL/s, less than or equal to about 50 mL/s, less than or equal to about 40 mL/s, less than or equal to about 30 mL/s, less than or equal to about 20 mL/s, less than or equal to about 10 mL/s, less than or equal to about 5 mL/s, less than or equal to about 4 mL/s, or any range or value including and/or in between any two of these values.

In some embodiments, the water is extracted at a rate of between about 1 mL/s and about 5 mL/s, between about 1 mL/s and about 10 mL/s, between about 1 mL/s and about 50 mL/s, between about 1 mL/s and about 100 mL/s, between about 1 mL/s and about 500 mL/s, between about 1 mL/s and about 1000 mL/s, between about 1 mL/s and about 2000 mL/s, between about 1 mL/s and about 3000 mL/s, between about 1 mL/s and about 4000 mL/s, between about 5 mL/s and about 10 mL/s, between about 5 mL/s and about 50 mL/s, between about 5 mL/s and about 100 mL/s, between about 5 mL/s and about 500 mL/s, between about 5 mL/s and about 1000 mL/s, between about 5 mL/s and about 2000 mL/s, between about 5 mL/s and about 3000 mL/s, between about 5 mL/s and about 4000 mL/s, between about 10 mL/s and about 50 mL/s, between about 10 mL/s and about 100 mL/s, between about 10 mL/s and about 500 mL/s, between about 10 mL/s and about 1000 mL/s, between about 10 mL/s and about 2000 mL/s, between about 10 mL/s and about 3000 mL/s, between about 10 mL/s and about 4000 mL/s, between about 50 mL/s and about 100 mL/s, between about 50 mL/s and about 500 mL/s, between about 50 mL/s and about 1000 mL/s, between about 50 mL/s and about 2000 mL/s, between about 50 mL/s and about 3000 mL/s, between about 50 mL/s and about 4000 mL/s, between about 100 mL/s and about 500 mL/s, between about 100 mL/s and about 1000 mL/s, between about 100 mL/s and about 2000 mL/s, between about 100 mL/s and about 3000 mL/s, between about 100 mL/s and about 4000 mL/s, between about 500 mL/s and about 1000 mL/s, between about 500 mL/s and about 2000 mL/s, between about 500 mL/s and about 3000 mL/s, between about 500 mL/s and about 4000 mL/s, between about 1000 mL/s and about 2000 mL/s, between about 1000 mL/s and about 3000 mL/s, between about 1000 mL/s and about 4000 mL/s, between about 2000 mL/s and about 3000 mL/s, between about 2000 mL/s and about 4000 mL/s, between about 3000 mL/s and about 4000 mL/s, or any range or value therein between.

In some embodiments, a fuel cell cathode-side inlet receives air from an air compressor at a pressure of less than or equal to about 3 bar, less than or equal to about 2.5 bar, less than or equal to about 2 bar, less than or equal to about 1.5 bar, less than or equal to about 1 bar, less than or equal to about 0.5 bar, or any range or value including and/or in between any two of these values.

In some embodiments, the air has an oxygen concentration of at least about 10 vol. %, at least about 20 vol. %, at least about 30 vol. %, at least about 40 vol. %, at least about 50 vol. %, at least about 60 vol. %, at least about 70 vol. %, at least about 80 vol. %, at least about 90 vol. %, or any range or value including and/or in between any two of these values.

In some embodiments, the air has an oxygen concentration of less than or equal to about 90 vol. %, less than or equal to about 80 vol. %, less than or equal to about 70 vol. %, less than or equal to about 60 vol. %, less than or equal to about 50 vol. %, less than or equal to about 40 vol. %, less than or equal to about 30 vol. %, less than or equal to about 20 vol. %, less than or equal to about 10 vol. %, or any range or value including and/or in between any two of these values.

In some embodiments, the air has an oxygen concentration of between about 10 vol. % and about 20 vol. %, between about 10 vol. % and about 30 vol. %, between about 10 vol. % and about 40 vol. %, between about 10 vol. % and about 50 vol. %, between about 10 vol. % and about 60 vol. %, between about 10 vol. % and about 70 vol. %, between about 10 vol. % and about 80 vol. %, between about 10 vol. % and about 90 vol. %, between about 20 vol. % and about 30 vol. %, between about 20 vol. % and about 40 vol. %, between about 20 vol. % and about 50 vol. %, between about 20 vol. % and about 60 vol. %, between about 20 vol. % and about 70 vol. %, between about 20 vol. % and about 80 vol. %, between about 20 vol. % and about 90 vol. %, between about 30 vol. % and about 40 vol. %, between about 30 vol. % and about 50 vol. %, between about 30 vol. % and about 60 vol. %, between about 30 vol. % and about 70 vol. %, between about 30 vol. % and about 80 vol. %, between about 30 vol. % and about 90 vol. %, between about 40 vol. % and about 50 vol. %, between about 40 vol. % and about 60 vol. %, between about 40 vol. % and about 70 vol. %, between about 40 vol. % and about 80 vol. %, between about 40 vol. % and about 90 vol. %, between about 50 vol. % and about 60 vol. %, between about 50 vol. % and about 70 vol. %, between about 50 vol. % and about 80 vol. %, between about 50 vol. % and about 90 vol. %, between about 60 vol. % and about 70 vol. %, between about 60 vol. % and about 80 vol. %, between about 60 vol. % and about 90 vol. %, between about 70 vol. % and about 80 vol. %, between about 70 vol. % and about 90 vol. %, between about 80 vol. % and about 90 vol. %, or any range or value therein between.

In some embodiments, a plurality of fuel cells operates in an electricity-producing mode and a plurality of fuel cells operate in a hydrogen-producing mode. In some embodiments, hydrogen produced by a fuel cell operating in a hydrogen-producing dilutes syngas at the anode-side of a fuel cell operating in electricity-producing mode, thereby preventing anode starvation. In some embodiments, a fuel cell enters hydrogen-production mode to rejuvenate the cathode. In some embodiments, a solvent or solvent mixture that can improve water evaporation and/or donate protons is applied to the cathode, thereby rejuvenating the cathode. In some embodiments the solvent is an alcohol, preferably methanol.

Thus, the hydrogen distribution device according to the present disclosure may be operated in a constant-current mode, whereby the amount of hydrogen recycled to the SMR burner and/or to the anode-side syngas inlet may be adjusted when the target potential difference between the anode and cathode of a particular fuel cell or a plurality of fuel cells reaches a target value. In some embodiments, an electronic control unit controls valves to (i) enter fuel cell electricity-producing mode, (ii) enter fuel cell hydrogen-producing mode, (iii) dilute syngas at the anode-side of the fuel cell, or (iv) apply a solvent to the fuel cell cathode.

In some embodiments, the electronic control unit controls valves when a fuel cell outputs a voltage deviating from a target voltage. In some embodiments, the voltage deviation is at least about 1 mV, at least about 5 mV, at least about 10 mV, at least about 15 mV, at least about 20 mV, at least about 25 mV, at least about 30 mV, at least about 35 mV, at least about 40 mV, at least about 45 mV, at least about 50 mV, at least about 55 mV, at least about 60 mV, at least about 65 mV, at least about 70 mV, at least about 75 mV, at least about 80 mV, at least about 85 mV, at least about 90 mV, at least about 95 mV, or at least about 100 mV.

In some embodiments, the voltage deviation is at most about 100 mV, at most about 95 mV, at most about 90 mV, at most about 85 mV, at most about 80 mV, at most about 75 mV, at most about 70 mV, at most about 65 mV, at most about 60 mV, at most about 55 mV, at most about 50 mV, at most about 45 mV, at most about 40 mV, at most about 35 mV, at most about 30 mV, at most about 25 mV, at most about 20 mV, at most about 15 mV, at most about 10 mV, at most about 5 mV, or at most about 1 mV.

In some embodiments, the voltage deviation is about 100 mV to about 90 mV, about 100 mV to about 80 mV, about 100 mV to about 70 mV, about 100 mV to about 60 mV, about 100 mV to about 50 mV, about 100 mV to about 40 mV, about 100 mV to about 30 mV, about 100 mV to about 20 mV, about 100 mV to about 10 mV, about 100 mV to about 1 mV, about 90 mV to about 80 mV, about 90 mV to about 70 mV, about 90 mV to about 60 mV, about 90 mV to about 50 mV, about 90 mV to about 40 mV, about 90 mV to about 30 mV, about 90 mV to about 20 mV, about 90 mV to about 10 mV, about 90 mV to about 1 mV, about 80 mV to about 70 mV, about 80 mV to about 60 mV, about 80 mV to about 50 mV, about 80 mV to about 40 mV, about 80 mV to about 30 mV, about 80 mV to about 20 mV, about 80 mV to about 10 mV, about 80 mV to about 1 mV, about 70 mV to about 60 mV, about 70 mV to about 50 mV, about 70 mV to about 40 mV, about 70 mV to about 30 mV, about 70 mV to about 20 mV, about 70 mV to about 10 mV, about 70 mV to about 1 mV, about 60 mV to about 50 mV, about 60 mV to about 40 mV, about 60 mV to about 30 mV, about 60 mV to about 20 mV, about 60 mV to about 10 mV, about 60 mV to about 1 mV, about 50 mV to about 40 mV, about 50 mV to about 30 mV, about 50 mV to about 20 mV, about 50 mV to about 10 mV, about 50 mV to about 1 mV, about 40 mV to about 30 mV, about 40 mV to about 20 mV, about 40 mV to about 10 mV, about 40 mV to about 1 mV, about 30 mV to about 20 mV, about 30 mV to about 10 mV, about 30 mV to about 1 mV, about 20 mV to about 10 mV, about 20 mV to about 1 mV, or about 10 mV to about 1 mV.

In some embodiments, the target voltage is at most about 100 mV, at most about 125 mV, at most about 150 mV, at most about 175 mV, at most about 200 mV, at most about 225 mV, at most about 250 mV, at most about 275 mV, at most about 300 mV, at most about 325 mV, at most about 350 mV, at most about 375 mV, at most about 400 mV, at most about 425 mV, at most about 450 mV, at most about 475 mV, at most about 500 mV, at most about 525 mV, at most about 550 mV, at most about 575 mV, at most about 600 mV, at most about 625 mV, at most about 650 mV, at most about 675 mV, at most about 700 mV, at most about 725 mV, at most about 750 mV, at most about 775 mV, at most about 800 mV, at most about 825 mV, at most about 850 mV, at most about 875 mV, at most about 900 mV, at most about 925 mV, at most about 950 mV, at most about 975 mV, or at most about 1000 mV.

In some embodiments, the target voltage is at most about 1000 mV, at most about 975 mV, at most about 950 mV, at most about 925 mV, at most about 900 mV, at most about 875 mV, at most about 850 mV, at most about 825 mV, at most about 800 mV, at most about 775 mV, at most about 750 mV, at most about 725 mV, at most about 700 mV, at most about 675 mV, at most about 650 mV, at most about 625 mV, at most about 600 mV, at most about 575 mV, at most about 550 mV, at most about 525 mV, at most about 500 mV, at most about 475 mV, at most about 450 mV, at most about 425 mV, at most about 400 mV, at most about 375 mV, at most about 350 mV, at most about 325 mV, at most about 300 mV, at most about 275 mV, at most about 250 mV, at most about 225 mV, at most about 200 mV, at most about 175 mV, at most about 150 mV, at most about 125 mV, or at most about 100 mV.

In some embodiments, the target voltage is about 1000 mV to about 900 mV, about 1000 mV to about 800 mV, about 1000 mV to about 700 mV, about 1000 mV to about 600 mV, about 1000 mV to about 500 mV, about 1000 mV to about 400 mV, about 1000 mV to about 300 mV, about 1000 mV to about 200 mV, about 1000 mV to about 100 mV, about 900 mV to about 800 mV, about 900 mV to about 700 mV, about 900 mV to about 600 mV, about 900 mV to about 500 mV, about 900 mV to about 400 mV, about 900 mV to about 300 mV, about 900 mV to about 200 mV, about 900 mV to about 100 mV, about 800 mV to about 700 mV, about 800 mV to about 600 mV, about 800 mV to about 500 mV, about 800 mV to about 400 mV, about 800 mV to about 300 mV, about 800 mV to about 200 mV, about 800 mV to about 100 mV, about 700 mV to about 600 mV, about 700 mV to about 500 mV, about 700 mV to about 400 mV, about 700 mV to about 300 mV, about 700 mV to about 200 mV, about 700 mV to about 100 mV, about 600 mV to about 500 mV, about 600 mV to about 400 mV, about 600 mV to about 300 mV, about 600 mV to about 200 mV, about 600 mV to about 100 mV, about 500 mV to about 400 mV, about 500 mV to about 300 mV, about 500 mV to about 200 mV, about 500 mV to about 100 mV, about 400 mV to about 300 mV, about 400 mV to about 200 mV, about 400 mV to about 100 mV, about 300 mV to about 200 mV, about 300 mV to about 100 mV, or about 200 mV to about 100 mV.

### Integrated Co₂ Separation System

In some embodiments, the hydrogen distribution system further comprises a system for separating carbon oxides (e.g., CO₂, CO, or combinations thereof) and other emissions or reaction byproducts from the hydrogen present in the hydrogen-depleted syngas. Such separation systems are capable of separating CO₂ from a gas stream, regardless of concentration of the other gases present. The process achieves CO₂ liquefaction while simultaneously capturing and utilizing heat from compression to raise the temperature of a natural gas stream or other beneficial use. This integrated system may combine, for example, multi-stage compression, partial condensation, flash separation, and intercooler heat recovery, offering an efficient route to separate and liquefy one or more carbon oxides (e.g., CO₂) and other emissions or reaction byproducts, while simultaneously heating a hydrocarbon fuel (e.g., natural gas). The integrated system reduces overall energy consumption and optimizes resource utilization in processes where hydrogen, carbon dioxide, and heat are produced.

In some embodiments, a fuel cell anode-side outlet outputs a hydrogen-depleted syngas comprising carbon oxides (e.g., CO₂, CO, or a combination thereof) at a concentration of at least about 40 vol. %, at least about 50 vol. %, at least about 60 vol. %, at least about 70 vol. %, at least about 80 vol. %, at least about 90 vol. %, or any range or value including and/or in between any two of these values.

In some embodiments, the fuel cell anode-side outlet outputs a hydrogen-depleted syngas comprising carbon oxides (e.g., CO₂, CO, or a combination thereof) at a concentration of less than or equal to about 90 vol. %, less than or equal to about 80 vol. %, less than or equal to about 70 vol. %, less than or equal to about 60 vol. %, less than or equal to about 50 vol. %, or any range or value including and/or in between any two of these values.

In some embodiments, the fuel cell anode-side outlet outputs a hydrogen-depleted syngas comprising a carbon oxides concentration of between about 50 vol. % and about 60 vol. %, between about 50 vol. % and about 70 vol. %, between about 50 vol. % and about 80 vol. %, between about 50 vol. % and about 90 vol. %, between about 60 vol. % and about 70 vol. %, between about 60 vol. % and about 80 vol. %, between about 60 vol. % and about 90 vol. %, between about 70 vol. % and about 80 vol. %, between about 70 vol. % and about 90 vol. %, between about 80 vol. % and about 90 vol. %, or any range or value therein between.

In some embodiments, the remainder of the hydrogen-depleted syngas (the portion that is not carbon oxides) is substantially hydrogen. For instance, in some embodiments, the hydrogen-depleted syngas comprises about 50-70 vol. % carbon oxides (e.g., CO₂, CO, or a combination thereof) and about 30-50 vol. % hydrogen. In some embodiments, the hydrogen-depleted syngas comprises about 55-65 vol. % carbon oxides (e.g., CO₂, CO, or a combination thereof) and about 35-45 vol. % hydrogen. In some embodiments, the hydrogen-depleted syngas about 60 vol. % carbon oxides (e.g., CO₂, CO, or a combination thereof) and about 40 vol. % hydrogen.

In some embodiments, the hydrogen-depleted syngas comprising carbon oxides is compressed with an, optionally intercooled, multi-stage compressor from a first pressure of about 0.5 bar, 1 bar, 1.5 bar, 2 bar, 2.5 bar, or 3 bar to a second pressure of about 10 bar, 15 bar, 20 bar, 25 bar, or 30 bar.

In some embodiments, the first pressure is at least about 0.5 bar, at least about 1 bar, at least about 1.5 bar, at least about 2 bar, at least about 2.5 bar, at least about 3 bar, or any range or value including and/or in between any two of these values.

In some embodiments, the first pressure is less than or equal to about 3 bar, less than or equal to about 2.5 bar, less than or equal to about 2 bar, less than or equal to about 1.5 bar, less than or equal to about 1 bar, less than or equal to about 0.5 bar, or any range or value including and/or in between any two of these values.

In some embodiments, the first pressure is between about 0.5 bar and about 1 bar, between about 0.5 bar and about 1.5 bar, between about 0.5 bar and about 2 bar, between about 0.5 bar and about 2.5 bar, between about 0.5 bar and about 3 bar, between about 1 bar and about 1.5 bar, between about 1 bar and about 2 bar, between about 1 bar and about 2.5 bar, between about 1 bar and about 3 bar, between about 1.5 bar and about 2 bar, between about 1.5 bar and about 2.5 bar, between about 1.5 bar and about 3 bar, between about 2 bar and about 2.5 bar, between about 2 bar and about 3 bar, between about 2.5 bar and about 3 bar, or any range or value therein between.

In some embodiments, the second pressure is at least about 10 bar, at least about 15 bar, at least about 20 bar, at least about 25 bar, at least about 30 bar, or any range or value including and/or in between any two of these values.

In some embodiments, the second pressure is less than or equal to about 30 bar, less than or equal to about 25 bar, less than or equal to about 20 bar, less than or equal to about 15 bar, less than or equal to about 10 bar, or any range or value including and/or in between any two of these values.

In some embodiments, the second pressure is between about 10 bar and about 15 bar, between about 10 bar and about 20 bar, between about 10 bar and about 25 bar, between about 10 bar and about 30 bar, between about 15 bar and about 20 bar, between about 15 bar and about 25 bar, between about 15 bar and about 30 bar, between about 20 bar and about 25 bar, between about 20 bar and about 30 bar, between about 25 bar and about 30 bar, or any range or value therein between.

In some embodiments, the mechanical shaft power for compression is about 7.5 kW to about 8 kW.

In some embodiments, the mechanical shaft power for compression is at least about 5 kW, at least about 6 kW, at least about 7 kW, at least about 8 kW, at least about 9 kW, at least about 10 kW, or any range or value including and/or in between any two of these values.

In some embodiments, the mechanical shaft power for compression less than or equal to about 10 kW, less than or equal to about 9 kW, less than or equal to about 8 kW, less than or equal to about 7 kW, less than or equal to about 6 kW, less than or equal to about 5 kW, or any range or value including and/or in between any two of these values.

In some embodiments, the mechanical shaft power for compression is between about 5 kW and about 6 kW, between about 5 kW and about 7 kW, between about 5 kW and about 8 kW, between about 5 kW and about 9 kW, between about 5 kW and about 10 kW, between about 6 kW and about 7 kW, between about 6 kW and about 8 kW, between about 6 kW and about 9 kW, between about 6 kW and about 10 kW, between about 7 kW and about 8 kW, between about 7 kW and about 9 kW, between about 7 kW and about 10 kW, between about 8 kW and about 9 kW, between about 8 kW and about 10 kW, between about 9 kW and about 10 kW, or any range or value therein between.

In some embodiments, a refrigeration unit cools the compressed hydrogen-depleted syngas comprising carbon oxides to partially condense carbon oxides into a liquid.

In some embodiments, the refrigeration unit consumes at least about 1 kW, at least about 1.5 kW, at least about 2 kW, at least about 2.5 kW, at least about 3 kW, at least about 3.5 kW, at least about 4 kW, at least about 4.5 kW, at least about 5 kW, or any range or value including and/or in between any two of these values.

In some embodiments, the refrigeration unit consumes less than or equal to about 5 kW, less than or equal to about 4.5 kW, less than or equal to about 4 kW, less than or equal to about 3.5 kW, less than or equal to about 3 kW, less than or equal to about 2.5 kW, less than or equal to about 2 kW, less than or equal to about 1.5 kW, less than or equal to about 1 kW, or any range or value including and/or in between any two of these values.

In some embodiments, the refrigeration unit consumes between about 1 kW and about 1.5 kW, between about 1 kW and about 2 kW, between about 1 kW and about 2.5 kW, between about 1 kW and about 3 kW, between about 1 kW and about 3.5 kW, between about 1 kW and about 4 kW, between about 1 kW and about 4.5 kW, between about 1 kW and about 5 kW, between about 1.5 kW and about 2 kW, between about 1.5 kW and about 2.5 kW, between about 1.5 kW and about 3 kW, between about 1.5 kW and about 3.5 kW, between about 1.5 kW and about 4 kW, between about 1.5 kW and about 4.5 kW, between about 1.5 kW and about 5 kW, between about 2 kW and about 2.5 kW, between about 2 kW and about 3 kW, between about 2 kW and about 3.5 kW, between about 2 kW and about 4 kW, between about 2 kW and about 4.5 kW, between about 2 kW and about 5 kW, between about 2.5 kW and about 3 kW, between about 2.5 kW and about 3.5 kW, between about 2.5 kW and about 4 kW, between about 2.5 kW and about 4.5 kW, between about 2.5 kW and about 5 kW, between about 3 kW and about 3.5 kW, between about 3 kW and about 4 kW, between about 3 kW and about 4.5 kW, between about 3 kW and about 5 kW, between about 3.5 kW and about 4 kW, between about 3.5 kW and about 4.5 kW, between about 3.5 kW and about 5 kW, between about 4 kW and about 4.5 kW, between about 4 kW and about 5 kW, between about 4.5 kW and about 5 kW, or any range or value therein between.

In some embodiments, a flash vessel separates liquid carbon oxides from gaseous hydrogen. In some embodiments, the flash vessel is operated at about 20 bar.

In some embodiments, the flash vessel is operated at least about 10 bar, at least about 15 bar, at least about 20 bar, at least about 25 bar, at least about 30 bar, or any range or value including and/or in between any two of these values.

In some embodiments, the flash vessel is operated at less than or equal to about 30 bar, less than or equal to about 25 bar, less than or equal to about 20 bar, less than or equal to about 15 bar, less than or equal to about 10 bar, or any range or value including and/or in between any two of these values.

In some embodiments, the flash vessel is operated at between about 10 bar and about 15 bar, between about 10 bar and about 20 bar, between about 10 bar and about 25 bar, between about 10 bar and about 30 bar, between about 15 bar and about 20 bar, between about 15 bar and about 25 bar, between about 15 bar and about 30 bar, between about 20 bar and about 25 bar, between about 20 bar and about 30 bar, between about 25 bar and about 30 bar, or any range or value therein between.

In some embodiments, liquid carbon oxides are produced at a rate of about 63 kg/h. In some embodiments, gaseous hydrogen is produced at a rate of about 1.9 kg/h.

In some embodiments, liquid carbon oxides are produced at a rate of at least about 40 kg/h, at least about 50 kg/h, at least about 60 kg/h, at least about 70 kg/h, at least about 80 kg/h, or any range or value including and/or in between any two of these values.

In some embodiments, liquid carbon oxides are produced at a rate of less than or equal to about 80 kg/h, less than or equal to about 70 kg/h, less than or equal to about 60 kg/h, less than or equal to about 50 kg/h, less than or equal to about 40 kg/h, or any range or value including and/or in between any two of these values.

In some embodiments, liquid carbon oxides are produced at a rate of between about 40 kg/h and about 50 kg/h, between about 40 kg/h and about 60 kg/h, between about 40 kg/h and about 70 kg/h, between about 40 kg/h and about 80 kg/h, between about 50 kg/h and about 60 kg/h, between about 50 kg/h and about 70 kg/h, between about 50 kg/h and about 80 kg/h, between about 60 kg/h and about 70 kg/h, between about 60 kg/h and about 80 kg/h, between about 70 kg/h and about 80 kg/h, or any range or value therein between.

In some embodiments, gaseous hydrogen is produced at a rate of at least about 1 kg/h, at least about 1.5 kg/h, at least about 2 kg/h, at least about 2.5 kg/h, at least about 3 kg/h, or any range or value including and/or in between any two of these values.

In some embodiments, gaseous hydrogen is produced at a rate of less than or equal to about 3 kg/h, less than or equal to about 2.5 kg/h, less than or equal to about 2 kg/h, less than or equal to about 1.5 kg/h, less than or equal to about 1 kg/h, less than or equal to about 0.5 kg/h, or any range or value including and/or in between any two of these values.

In some embodiments, gaseous hydrogen is produced at a rate of between about 1 kg/h and about 1.5 kg/h, between about 1 kg/h and about 2 kg/h, between about 1 kg/h and about 2.5 kg/h, between about 1 kg/h and about 3 kg/h, between about 1.5 kg/h and about 2 kg/h, between about 1.5 kg/h and about 2.5 kg/h, between about 1.5 kg/h and about 3 kg/h, between about 2 kg/h and about 2.5 kg/h, between about 2 kg/h and about 3 kg/h, between about 2.5 kg/h and about 3 kg/h, or any range or value therein between.

In some embodiments, liquid carbon oxides are transferred to a pressurized storage tank. In some embodiments, the gaseous hydrogen is used as a fuel.

In some embodiments, the multi-stage compressor releases about 5 kW to about 6 kW of recoverable energy.

In some embodiments, the multi-stage compressor releases at least about 2 kW, at least about 3 kW, at least about 4 kW, at least about 5 kW, at least about 6 kW, at least about 7 kW, at least about 8 kW, at least about 9 kW, at least about 10 kW, or any range or value including and/or in between any two of these values.

In some embodiments, the multi-stage compressor releases less than or equal to about 10 kW, less than or equal to about 9 kW, less than or equal to about 8 kW, less than or equal to about 7 kW, less than or equal to about 6 kW, less than or equal to about 5 kW, less than or equal to about 4 kW, less than or equal to about 3 kW, less than or equal to about 2 kW, or any range or value including and/or in between any two of these values.

In some embodiments, the multi-stage compressor releases between about 2 kW and about 3 kW, between about 2 kW and about 4 kW, between about 2 kW and about 5 kW, between about 2 kW and about 6 kW, between about 2 kW and about 7 kW, between about 2 kW and about 8 kW, between about 2 kW and about 9 kW, between about 2 kW and about 10 kW, between about 3 kW and about 4 kW, between about 3 kW and about 5 kW, between about 3 kW and about 6 kW, between about 3 kW and about 7 kW, between about 3 kW and about 8 kW, between about 3 kW and about 9 kW, between about 3 kW and about 10 kW, between about 4 kW and about 5 kW, between about 4 kW and about 6 kW, between about 4 kW and about 7 kW, between about 4 kW and about 8 kW, between about 4 kW and about 9 kW, between about 4 kW and about 10 kW, between about 5 kW and about 6 kW, between about 5 kW and about 7 kW, between about 5 kW and about 8 kW, between about 5 kW and about 9 kW, between about 5 kW and about 10 kW, between about 6 kW and about 7 kW, between about 6 kW and about 8 kW, between about 6 kW and about 9 kW, between about 6 kW and about 10 kW, between about 7 kW and about 8 kW, between about 7 kW and about 9 kW, between about 7 kW and about 10 kW, between about 8 kW and about 9 kW, between about 8 kW and about 10 kW, between about 9 kW and about 10 kW, or any range or value therein between.

In some embodiments, the recoverable energy heats a hydrocarbon fuel or a hydrocarbon reformer, thereby utilizing the recoverable energy. In some embodiments, 1.65 kW of recovered energy heats 15 kg/h of natural gas from about 20° C. to about 200° C.

In some embodiments, the power draw required to liquify and capture carbon oxides is about 10 kW to about 12 kW.

In some embodiments, the power draw required to liquify and capture carbon oxides is at least about 7 kW, at least about 8 kW, at least about 9 kW, at least about 10 kW, at least about 11 kW, at least about 12 kW, at least about 13 kW, at least about 14 kW, at least about 15 kW, or any range or value including and/or in between any two of these values.

In some embodiments, the power draw required to liquify and capture carbon oxides is less than or equal to about 15 kW, less than or equal to about 14 kW, less than or equal to about 13 kW, less than or equal to about 12 kW, less than or equal to about 11 kW, less than or equal to about 10 kW, less than or equal to about 9 kW, less than or equal to about 8 kW, less than or equal to about 7 kW, or any range or value including and/or in between any two of these values.

In some embodiments, the power draw required to liquify and capture carbon oxides is between about 7 kW and about 8 kW, between about 7 kW and about 9 kW, between about 7 kW and about 10 kW, between about 7 kW and about 11 kW, between about 7 kW and about 12 kW, between about 7 kW and about 13 kW, between about 7 kW and about 14 kW, between about 7 kW and about 15 kW, between about 8 kW and about 9 kW, between about 8 kW and about 10 kW, between about 8 kW and about 11 kW, between about 8 kW and about 12 kW, between about 8 kW and about 13 kW, between about 8 kW and about 14 kW, between about 8 kW and about 15 kW, between about 9 kW and about 10 kW, between about 9 kW and about 11 kW, between about 9 kW and about 12 kW, between about 9 kW and about 13 kW, between about 9 kW and about 14 kW, between about 9 kW and about 15 kW, between about 10 kW and about 11 kW, between about 10 kW and about 12 kW, between about 10 kW and about 13 kW, between about 10 kW and about 14 kW, between about 10 kW and about 15 kW, between about 11 kW and about 12 kW, between about 11 kW and about 13 kW, between about 11 kW and about 14 kW, between about 11 kW and about 15 kW, between about 12 kW and about 13 kW, between about 12 kW and about 14 kW, between about 12 kW and about 15 kW, between about 13 kW and about 14 kW, between about 13 kW and about 15 kW, between about 14 kW and about 15 kW, or any range or value therein between.

### EXAMPLES

Fuel cell systems comprising hydrogen distribution systems according to the present disclosure will now be described with respect to particular exemplary embodiments, which are not intended to limit the scope of the present disclosure. For all examples discussed below, fuel cell systems comprising hydrogen distribution systems were constructed as described above in the Detailed Description, though persons of ordinary skill in the art will understand that other device constructions are possible and would not depart from the scope and spirit of this disclosure.

### Example 1. Fuel Cell System Mobile Applications

Fuel cell systems comprising hydrogen distribution devices according to the present disclosure provides a versatile solution for powering mobile applications across various industries. By efficiently converting hydrocarbon into hydrogen, the presently disclosed technology provides a continuous, scalable hydrogen supply that can be stored or used immediately to generate electricity via fuel cells. The presently disclosed technology is particularly transformative for applications where reducing emissions and achieving high energy efficiency are critical.

For instance, in industrial equipment, the presently disclosed technology can replace diesel engines, providing clean energy for machinery such as forklifts, cranes, and excavators. Said machinery often operates in confined spaces where air quality is a concern, and the presently disclosed technology reduces harmful emissions such as particulate matter and nitrogen oxides. Additionally, the lower noise levels of presently disclosed technology improves operator comfort and reduces workplace noise pollution.

Agricultural equipment, such as tractors and harvesters, can also benefit immensely from the presently disclosed technology. The presently disclosed technology offers a cleaner alternative to traditional diesel engines, reducing the environmental impact of farming operations. By powering such equipment with the presently disclosed technology, farms can operate more sustainably, particularly when the presently disclosed technology is integrated with renewable biogas sources derived from agricultural waste.

Furthermore, public transit systems, including buses, are an ideal application for the presently disclosed technology. Buses can travel long distances on a single hydrocarbon tank, emit primarily water vapor, and operate more quietly than their internal combustion counterparts. A facility at a central depot could produce renewable hydrocarbons to fuel the technology of the present disclosure on-site, ensuring a consistent and economical supply while significantly reducing greenhouse gas emissions in urban areas.

In the automotive sector, fuel cells are increasingly seen as a viable alternative to battery-electric vehicles. The presently disclosed technology offers quick refueling and long driving ranges, making the presently disclosed technology especially appealing for individuals or fleets that require extended operational capabilities without long charging times.

Ships represent a significant source of global pollution due to their reliance on heavy fuel oils. By replacing these with the presently disclosed technology, the shipping industry can drastically reduce emissions of sulfur oxides, nitrogen oxides, and carbon oxides. Ships powered by the presently disclosed technology also benefit from reduced noise and vibration, which is advantageous for both crew comfort and marine ecosystems.

The aviation industry presents unique challenges for decarbonization, but the presently disclosed technology can address these. Small and medium-sized planes can use the presently disclosed technology to power propulsion, offering a cleaner alternative to propulsion powered by traditional aviation fuels.

Rail transport, including both passenger and freight trains, is another promising application. The presently disclosed technology provides a flexible and low-emission power source for trains operating on non-electrified tracks.

In urban logistics, delivery vans and trucks equipped with the presently disclosed technology offer a clean and efficient alternative for last-mile delivery, thereby reducing emissions in densely populated areas.

The presently disclosed technology also holds potential for powering military vehicles and equipment. The low thermal and noise signatures of the presently disclosed technology is ideal for tactical applications.

Portable power units for events, construction sites, or disaster relief can also benefit from the presently disclosed technology. The presently disclosed technology provides a clean and quiet power source, and a mobile power unit of the present disclosure can ensure a steady electricity supply even in off-grid locations.

Further, the presently disclosed technology can play a critical role in the development of autonomous vehicles across various sectors. The long operational range and reliability of the presently disclosed technology is ideal for autonomous systems requiring extended uptime and minimal human intervention.

### Example 2. Fuel Cell System Stationary Applications

Fuel cell systems comprising hydrogen distribution devices according to the present disclosure also provides a versatile solution for powering stationary applications across various industries. The presently disclosed technology is particularly transformative for applications where reducing emissions and achieving high energy efficiency are critical.

For instance, in residential microgrids, the presently disclosed technology can provide a reliable energy source for households. These systems can operate independently or supplement the main power grid, offering resilience during outages and reducing dependence on fossil fuels. The presently disclosed technology allows for energy use during peak demand or when renewable energy sources like solar are unavailable.

A residential microgrid using the presently disclosed technology can work alongside renewable energy systems like solar panels or wind turbines. Excess renewable electricity can power an electrolyzer to produce hydrogen, which complements the presently disclosed technology during low renewable output periods. This synergy enhances the microgrid's reliability and minimizes emissions.

When the presently disclosed technology generate electricity, they also produce waste heat, which can be captured for heating purposes. This combined heat and power (CHP) approach maximizes energy use efficiency in residential settings, reducing the need for separate heating systems and lowering overall energy costs.

In larger residential communities or apartment complexes, the presently disclosed technology can power multiple households. This shared infrastructure reduces costs and simplifies maintenance while providing a cleaner alternative to traditional power sources.

In remote areas lacking access to a reliable power grid, the presently disclosed technology can provide a dependable energy source. These systems are particularly valuable in regions where transporting diesel or other fuels is expensive or logistically challenging, as natural gas pipelines or biogas from local sources can feed the presently disclosed technology.

The presently disclosed technology can also address methane emissions in industrial processes by capturing and reforming methane into hydrogen. This abatement strategy reduces greenhouse gas emissions while providing a clean fuel source for fuel cells, enabling industries to meet environmental regulations and sustainability goals.

Many industrial processes, such as ammonia production or metal refining, require large amounts of hydrogen. The presently disclosed technology can supply hydrogen for both these processes and on-site electricity generation, reducing reliance on external energy sources and lowering emissions.

Data centers require reliable and uninterrupted power. The presently disclosed technology offer a scalable and resilient solution, providing backup or primary power. The absence of combustion-based generators improves air quality and reduces environmental impact near data center sites.

Hospitals and other critical infrastructure need reliable power with no interruptions. The presently disclosed technology can serve as a primary or backup power source, ensuring a consistent supply of electricity and heat while reducing the facility's carbon footprint.

Wastewater treatment plants often emit biogas, a mixture of methane and carbon dioxide. This biogas can be used as a feedstock for the presently disclosed technology. This approach reduces methane emissions and turns waste into a valuable energy resource.

Agricultural facilities can utilize the presently disclosed technology to reform biogas from manure or crop waste into hydrogen. This hydrogen can power fuel cells for electricity and heating, helping farms reduce methane emissions and energy costs while operating sustainably.

In utility-scale applications, the presently disclosed technology can produce hydrogen for fuel cells that provide energy during peak demand periods, helping balance the grid and prevent blackouts. This reduces the need for peaking power plants that typically rely on fossil fuels.

Commercial buildings can use the presently disclosed technology as a backup energy source, ensuring continuous operation during grid outages. These systems are quieter and cleaner than diesel generators, making them ideal for urban settings.

When integrated with carbon capture and storage (CCS) systems, the presently disclosed technology can produce low-carbon hydrogen for stationary fuel cell applications. Captured carbon can be utilized in other industrial processes, such as creating synthetic fuels or building materials.

The presently disclosed technology at hydrogen export facilities can produce hydrogen for both local and international markets. Fuel cells powered by this hydrogen can provide energy for port operations, ensuring that the hydrogen production process is itself sustainable.

As global energy systems transition toward hydrogen-based solutions, the presently disclosed technology will play a critical role in creating scalable and efficient energy infrastructure. These systems enable industries and communities to adapt to evolving energy needs while minimizing environmental impact.

The present disclosure has described the use of various features and methods for recycling hydrogen, hydrocarbons, and water using a hydrogen distribution device. It should be understood that any combination of such features and methods are within the scope of the present disclosure. For example, an embodiment that describes the use of a hydrocarbon reformer with methane may be modified to use a different fuel and hydrocarbon reformation process, and such modification is intended to be within the scope of the present disclosure. Other permutations and combinations that utilize one or more of the features/methods described herein are also possible, and such permutations and combinations are also considered part of the present disclosure without enumerating them specifically.

### Numbered Embodiments

1. A hydrogen distribution system comprising:
an air source;
a plurality of fuel cells, each fuel cell comprising:
   an anode;
   a cathode;
   an electrolyte membrane between the anode and the cathode;
   an anode-side syngas inlet configured to introduce a syngas to the anode from a hydrocarbon fuel reformer (HR);
   a cathode-side hydrogen outlet configured to output a purified hydrogen from the cathode and coupled to a hydrogen exhaust line having a first valve;
   an anode-side hydrogen inlet configured to introduce purified hydrogen from the hydrogen exhaust line to the anode and coupled to a second valve;
   a cathode-side air inlet configured to introduce air from the air source to the cathode and coupled to a third valve;
   an anode-side syngas outlet configured to output a hydrogen-depleted syngas to a HR burner;
   a cathode-side water exhaust outlet configured to output water from the cathode and coupled to a fourth valve; and
   an electronic control unit configured to electrically control the first valve, the second valve, the third valve, and the fourth valve,
   wherein the anode-side syngas outlet recycles hydrogen-depleted syngas, via an anode outlet line, to a HR burner used in the production of the syngas.

2. The hydrogen distribution system of embodiment 1, wherein:
the cathode-side water exhaust outlet recycles water to the HR via a cathode outlet line;
the first valve is opened and the third and fourth valves are closed in a hydrogen production mode, thereby reducing cathode impurities;
the first valve is closed and the third and fourth valves are opened in an electricity production mode; and
the second valve is opened to dilute the syngas with the purified hydrogen, thereby reducing anode impurities.

3. The hydrogen distribution system of embodiment 1, wherein the HR is a methane reformer configured to convert methane into hydrogen and carbon oxides via steam reformation and/or pyrolysis processes.

4. The hydrogen distribution system of embodiment 1, wherein the fuel cells are polymer electrolyte membrane fuel cells (PEMFCs).

5. The hydrogen distribution system of embodiment 4, wherein the PEMFCs each comprise one or more catalyst layers contacting the electrolyte membrane, and wherein the one or more catalyst layers comprise a platinum group metal (PGM).

6. The hydrogen distribution system of embodiment 5, wherein the PGM is selected from the group consisting of platinum, palladium, rhodium, ruthenium, osmium, and iridium.

7. The hydrogen distribution system of embodiment 1, wherein each of the fuel cells in the plurality of fuel cells is configured to operate in two modes:
(1) an electricity-producing mode to produce electricity using hydrogen in the syngas; and
(2) a hydrogen-producing mode to consume electricity and produce hydrogen for use in the HR burner, for storage, or for distribution,

wherein the mode of a fuel cell is selected based on a voltage produced by the fuel cell.

8. The hydrogen distribution system of embodiment 1, wherein at least one of the plurality of fuel cells further comprises a cathode-side liquid (e.g., methanol, water, and their mixtures) inlet coupled to a fifth valve, and wherein the cathode-side methanol inlet is configured to supply methanol to the cathode to increase electrical output of the fuel cell.

9. a fuel cell system comprising:
a HR configured to convert a hydrocarbon fuel into a syngas;
a burner configured to heat the HR; and
the hydrogen distribution system according to embodiment 1 in fluid communication with the anode-side syngas inlet and the cathode-side hydrogen exhaust outlet;
wherein the HR comprises an HR outlet coupled to the anode-side syngas inlet by an anode syngas inlet line;
wherein excess hydrogen is transferred from the anode-side outlet into the burner via the anode outlet line;
wherein water is transferable from the cathode-side water exhaust outlet to the HR via a water exhaust line;
wherein air is introduced from an air compressor into the cathode-side air inlet; and
wherein the cathode-side air outlet outputs air exhaust from the cathode into an air exhaust line configured to introduce air into the burner.

10. The fuel cell system of embodiment 9, wherein the plurality of fuel cells are polymer electrolyte membrane fuel cells (PEMFCs).

11. The fuel cell system of embodiment 10, wherein the PEMFCs each comprise one or more catalyst layers contacting the electrolyte membrane, and wherein the one or more catalyst layers comprise a platinum group metal (PGM).

12. The fuel cell system of embodiment 11, wherein the PGM is selected from the group consisting of platinum, palladium, rhodium, ruthenium, osmium, and iridium.

13. The fuel cell system of embodiment 9, wherein:
the fuel is methane, the HR is a SMR, and the methane is introduced into the SMR at <5 bar; and
the syngas is introduced into the anode-side syngas inlet at <3 bar.

14. The fuel cell system of embodiment 9, wherein at least one of the plurality of fuel cells further comprises a cathode-side methanol/water mixture inlet coupled to a fifth valve, and wherein the cathode-side methanol/water inlet is configured to supply methanol to the cathode to increase electrical output of the fuel cell.

15. A method for operating a fuel cell system, comprising:
providing the fuel cell system according to embodiment 9;
producing syngas using the HR, wherein the HR is heated by the burner;
introducing the syngas into the hydrogen distribution system via an anode-side syngas inlet line coupled to the anode-side syngas inlet, wherein the syngas is introduced into a fuel cell at the anode-side syngas inlet;
producing electricity by consuming hydrogen gas in the syngas via the fuel cell;
outputting excess hydrogen via the anode-side exhaust outlet to the burner to heat the HR.

16. The method of embodiment 15, further comprising:
producing water at the fuel cell on the cathode side and transferring the water from the cathode-side water exhaust outlet into the HR;
transferring air exhaust from the cathode via the cathode-side air outlet into the burner.

17. The method of embodiment 15, further comprising:
operating a second fuel cell of the hydrogen distribution system in a hydrogen-producing mode to produce purified hydrogen gas at the cathode;
transferring the purified hydrogen gas via the cathode-side hydrogen outlet into at least one of:
   the hydrogen exhaust; or
   an anode-side inlet of a fuel cell in the hydrogen distribution system operating in an electricity-producing mode.

18. The method of embodiment 15, wherein one or more of the plurality of fuel cells are polymer electrolyte membrane fuel cells (PEMFCs).

19. The method of embodiment 18, wherein the PEMFCs each comprise one or more catalyst layers contacting the membrane, and wherein the one or more catalyst layers comprise a platinum group metal (PGM).

20. The method of embodiment 19, wherein the PGM is selected from the group consisting of platinum, palladium, rhodium, ruthenium, osmium, and iridium.

21. The method of embodiment 15, wherein:
the fuel is methane, the HR is a SMR, and the methane is introduced into the SMR at <5 bar; and
the syngas is introduced into the anode-side syngas inlet at <3 bar.

22. The method of embodiment 15, wherein an amount of excess hydrogen or purified hydrogen introduced into the HR is controlled by the electronic control unit based on (i) a voltage produced by the one or more of the plurality of fuel cells, and/or (ii) temperature of the burner.

23. The method of embodiment 15, further comprising providing methanol to a fuel cell cathode to increase electrical output of the fuel cell.

### Definitions and Equivalents

Notwithstanding the embodiments described above and shown in the accompanying drawing figures, various modifications and inclusions to those embodiments are contemplated and considered within the scope of the present disclosure.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Connections between different components in communication with one another may be wired or wireless. In Figures referring to connectivity of two or more components in communication with one another show lines indicating the communication between components. By default, where these lines intersect, no contact is indicated, unless marked with a “●”.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A hydrogen distribution system comprising:
an air source;
a plurality of fuel cells, each fuel cell comprising:
an anode;
a cathode;
an electrolyte membrane between the anode and the cathode;
an anode-side syngas inlet configured to introduce a syngas to the anode from a hydrocarbon fuel reformer (HR);
a cathode-side hydrogen outlet configured to output a purified hydrogen from the cathode and coupled to a hydrogen exhaust line having a first valve;
an anode-side hydrogen inlet configured to introduce purified hydrogen from the hydrogen exhaust line to the anode and coupled to a second valve;
a cathode-side air inlet configured to introduce air from the air source to the cathode and coupled to a third valve;
an anode-side syngas outlet configured to output a hydrogen-depleted syngas to a HR burner;
a cathode-side water exhaust outlet configured to output water from the cathode and coupled to a fourth valve; and
an electronic control unit configured to electrically control the first valve, the second valve, the third valve, and the fourth valve,
wherein the anode-side syngas outlet recycles hydrogen-depleted syngas, via an anode outlet line, to a HR burner used in the production of the syngas.

2. The hydrogen distribution system of claim 1, wherein:
the cathode-side water exhaust outlet recycles water to the HR via a cathode outlet line;
the first valve is opened and the third and fourth valves are closed in a hydrogen production mode, thereby reducing cathode impurities;
the first valve is closed and the third and fourth valves are opened in an electricity production mode; and
the second valve is opened to dilute the syngas with the purified hydrogen, thereby reducing anode impurities.

3. The hydrogen distribution system of claim 1, wherein the HR is a methane reformer configured to convert methane into hydrogen and carbon oxides via steam reformation and/or pyrolysis processes.

4. The hydrogen distribution system of claim 1, wherein the fuel cells are polymer electrolyte membrane fuel cells (PEMFCs).

5. The hydrogen distribution system of claim 4, wherein the PEMFCs each comprise one or more catalyst layers contacting the electrolyte membrane, and wherein the one or more catalyst layers comprise a platinum group metal (PGM).

6. The hydrogen distribution system of claim 1, wherein each of the fuel cells in the plurality of fuel cells is configured to operate in two modes:
(1) an electricity-producing mode to produce electricity using hydrogen in the syngas; and
(2) a hydrogen-producing mode to consume electricity and produce hydrogen for use in the HR burner, for storage, or for distribution,
wherein the mode of a fuel cell is selected based on a voltage produced by the fuel cell.

7. The hydrogen distribution system of claim 1, wherein at least one of the plurality of fuel cells further comprises a cathode-side liquid (e.g., methanol, water, and their mixtures) inlet coupled to a fifth valve, and wherein the cathode-side methanol inlet is configured to supply methanol to the cathode to increase electrical output of the fuel cell.

8. A fuel cell system comprising:
a HR configured to convert a hydrocarbon fuel into a syngas;
a burner configured to heat the HR; and
the hydrogen distribution system according to claim 1 in fluid communication with the anode-side syngas inlet and the cathode-side hydrogen exhaust outlet;
wherein the HR comprises an HR outlet coupled to the anode-side syngas inlet by an anode syngas inlet line;
wherein excess hydrogen is transferred from the anode-side outlet into the burner via the anode outlet line;
wherein water is transferable from the cathode-side water exhaust outlet to the HR via a water exhaust line;
wherein air is introduced from an air compressor into the cathode-side air inlet; and
wherein the cathode-side air outlet outputs air exhaust from the cathode into an air exhaust line configured to introduce air into the burner.

9. The fuel cell system of claim 8, wherein the plurality of fuel cells are polymer electrolyte membrane fuel cells (PEMFCs).

10. The fuel cell system of claim 9, wherein the PEMFCs each comprise one or more catalyst layers contacting the electrolyte membrane, and wherein the one or more catalyst layers comprise a platinum group metal (PGM).

11. The fuel cell system of claim 8, wherein:
the fuel is methane, the HR is a SMR, and the methane is introduced into the SMR at <5 bar; and
the syngas is introduced into the anode-side syngas inlet at <3 bar.

12. The fuel cell system of claim 8, wherein at least one of the plurality of fuel cells further comprises a cathode-side methanol/water mixture inlet coupled to a fifth valve, and wherein the cathode-side methanol/water inlet is configured to supply methanol to the cathode to increase electrical output of the fuel cell.

13. A method for operating a fuel cell system, comprising:
providing the fuel cell system according to claim 8;
producing syngas using the HR, wherein the HR is heated by the burner;
introducing the syngas into the hydrogen distribution system via an anode-side syngas inlet line coupled to the anode-side syngas inlet, wherein the syngas is introduced into a fuel cell at the anode-side syngas inlet;
producing electricity by consuming hydrogen gas in the syngas via the fuel cell;
outputting excess hydrogen via the anode-side exhaust outlet to the burner to heat the HR.

14. The method of claim 13, further comprising:
producing water at the fuel cell on the cathode side and transferring the water from the cathode-side water exhaust outlet into the HR;
transferring air exhaust from the cathode via the cathode-side air outlet into the burner.

15. The method of claim 13, further comprising:
operating a second fuel cell of the hydrogen distribution system in a hydrogen-producing mode to produce purified hydrogen gas at the cathode;
transferring the purified hydrogen gas via the cathode-side hydrogen outlet into at least one of:
the hydrogen exhaust; or
an anode-side inlet of a fuel cell in the hydrogen distribution system operating in an electricity-producing mode.

16. The method of claim 14, wherein one or more of the plurality of fuel cells are polymer electrolyte membrane fuel cells (PEMFCs).

17. The method of claim 16, wherein the PEMFCs each comprise one or more catalyst layers contacting the membrane, and wherein the one or more catalyst layers comprise a platinum group metal (PGM).

18. The method of claim 13, wherein:
the fuel is methane, the HR is a SMR, and the methane is introduced into the SMR at <5 bar; and
the syngas is introduced into the anode-side syngas inlet at <3 bar.

19. The method of claim 13, wherein an amount of excess hydrogen or purified hydrogen introduced into the HR is controlled by the electronic control unit based on (i) a voltage produced by the one or more of the plurality of fuel cells, and/or (ii) temperature of the burner.

20. The method of claim 13, further comprising providing methanol to a fuel cell cathode to increase electrical output of the fuel cell.
